(19) United States
(12) Patent Application Publication
(10) Pub. No.: US 2013/0132178 A1
(43) Pub. Date: May 23, 2013

(54) QUESTION AND ANSWER PROCESSING DEVICE, QUESTION AND ANSWER PROCESSING METHOD, QUESTION AND ANSWER PROCESSING PROGRAM, AND RECORDING MEDIUM

(71) Applicants: Soh Masuko, Shinagawa-ku (JP); Hiroshi Mikitani, Shinagawa-ku (JP)

(72) Inventors: Soh Masuko, Shinagawa-ku (JP); Hiroshi Mikitani, Shinagawa-ku (JP)

(73) Assignee: RAKUTEN, INC., Shinagawa-ku, Tokyo (JP)

(21) Appl. No.: 13/813,019

(22) PCT Filed: Feb. 7, 2012
(86) PCT No.: PCT/JP2012/052736

§ 371 Date: Jan. 29, 2013

(30) Foreign Application Priority Data
May 30, 2011 (JP) 2011-120447

(51) Int. Cl. G06Q 30/02

(52) U.S. Cl. CPC G06Q 30/0217
USPC 705/14.19

(57) ABSTRACT

A question and answer processing device receives question information, purchase history requirement information, and attribute requirement information from a questioner terminal device, acquires user identification information which has been searched for by a search means that searches for the user identification information of a user satisfying requirements indicated by the received purchase history requirement information and attribute requirement information, transmits the received question information to an answerer terminal device used by a user identified by the acquired user identification information, receives determined reward information, which indicates a reward determined by a questioner for answer information, from the questioner terminal device which receives the answer information transmitted from the answerer terminal device, and causes a storage means to store the received determined reward information in association with the user identification information of an answerer.

### TECHNICAL FIELD

The present invention relates to a technical field of a question and answer processing device and a question and answer processing method for exchanging questions and answers between users through a network.

### BACKGROUND ART

Conventionally, a Q&A system is known which exchanges questions and answers between users through a network such as the Internet. For example, question information inputted into a terminal device by a user is transmitted to a server device such as a Web server. The server device publishes the question information to the general public by posting the received question information on a Web page. Another user who browses the question information inputs answer information into a terminal device. The inputted answer information is transmitted to the server device and posted on a Web page in association with the question information. Thereby, the questioner can obtain answers from unspecified users.

Patent Literature 1 describes a technique for obtaining serious answers from answerers. Specifically, Patent Literature 1 describes that, when a server device calculates a membership fee of each member, the server device reduces the membership fee according to the number of answers adopted by questioners out of answers inputted by the member.

### CITATION LIST

### Patent Literature

Patent Literature 1: Japanese Patent Application Laid-Open No. 2004-94326

### SUMMARY OF INVENTION

### Technical Problem

By the way, it is assumed that a user considers, for example, purchasing a certain item for sale or service (hereinafter the item for sale and the service are collectively referred to as a “transaction target”). At this time, there is a case in which the user wants to ask a question about a transaction target and a purchase of the transaction target in the Q&A system. In this case, an answer obtained from a user who has an experience of actually purchasing the transaction target tends to be more credible than an answer from a user who has not purchased the transaction target. This is because an answer based on an experience of purchasing the transaction target and an experience of using the transaction target can be obtained from the user who has an experience of actually purchasing the transaction target. Therefore, there is a case in which the user, who is a questioner, wants to limit the users to be an answerer by a purchase history (purchase experience). Also, an attribute (for example, age, gender, and residential area) of a user to be an answerer is worth considering. This is because even users who have the same purchase history may have, for example, different forms of use of the purchased transaction target or different opinions to the transaction target depending on the attributes of the users. For example, the questioner thinks “I want to obtain an answer from a user who lives in a specific area and purchased a specific item for sale in a specific period of time”.

However, in the technique described in Patent Literature 1, it is not possible for the questioner to specify the purchase history and the attribute of the user to be the answerer. Therefore, unspecified users provide an answer, so that the questioner cannot necessarily obtain a credible answer.

The present invention is made in view of the above situation, and an object of the present invention is to provide a question and answer processing device, a question and answer processing method, a question and answer processing program, and a recording medium, which make it possible to obtain a serious answer from a user who has a purchase history and an attribute desired by a questioner.

### Solution to Problem

In order to achieve the above object, an invention described in claim 1 is a question and answer processing device to which terminal devices used by users to exchange questions and answers between users can be connected through a network, the question and answer processing device comprising: a question information reception means that receives question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user; an acquisition means that acquires user identification information having been searched for by a search means, the user identification information identifying a user, the search means searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information; a question information transmission means that transmits the received question information to an answerer terminal device being the terminal device used by a user identified by the acquired user identification information; a determined reward information reception means that receives determined reward information from the questioner terminal device having received answer information transmitted from the answerer terminal device, the determined reward information indicating a reward determined by a questioner for the answer information; and a storage control means that causes a storage means to store the received determined reward information in association with the user identification information of an answerer, the storage means storing information indicating things obtained by a user.

According to this invention, a user who satisfies the purchase history requirements and the attribute requirements specified by the questioner is searched for as a user to be an answerer and the question information is transmitted to the terminal device used by the user who has been searched for. The questioner can determine the reward to the answerer after checking the answer information from the user who actually provides an answer. Therefore, it is possible to obtain a serious answer from a user who has a purchase history and an attribute desired by the questioner.

An invention described in claim 2 is the question and answer processing device according to claim 1, wherein the question information reception means receives the question information, the purchase history requirement information, the attribute requirement information and rough estimate reward information from the questioner terminal device, the rough estimate reward information indicating a rough estimate of a reward estimated by the questioner, and the question information transmission means transmits the received question information and the received rough estimate reward information to the answerer terminal device.

According to this invention, the user to be an answerer can determine whether or not to provide an answer after checking the rough estimate of the reward that may be obtained if the user provides an answer.

An invention described in claim 3 is the question and answer processing device according to claim 2, further comprising: a reward history information storage means that stores reward history information in association with the user identification information of the questioner, the reward history information including the rough estimate reward information and the determined reward information which are received from the questioner terminal device; and a reward history information transmission means that transmits the reward history information having been stored so far in the reward history information storage means in association with the user identification information of the questioner to the answerer terminal device.

According to this invention, the user to be an answerer can check the rough estimates of the reward which were determined by the questioner in the past and the rewards which were actually given by the questioner. Therefore, the user can determine whether or not the questioner is a user who gives a reward according to the rough estimate of the reward.

An invention described in claim 4 is the question and answer processing device according to claim 3, further comprising: an answer information reception means that receives answer information from the answerer terminal device; and an answer information transmission means that transmits the received answer information to the questioner terminal device, wherein the reward history information storage means stores the reward history information including the rough estimate reward information, the determined reward information and the answer information, the rough estimate reward information and the determined reward information being received from the questioner terminal device, the answer information being received from the answerer terminal device.

According to this invention, the user to be an answerer can check the rough estimates of the reward which were determined by the questioner in the past, the rewards which were actually given by the questioner, and the answer content when the reward was given. Therefore, the user can determine what kind of answer the questioner prefers.

An invention described in claim 5 is the question and answer processing device according to any one of claims 2 to 4, wherein in the storage means, coupon information indicating a coupon being able to be used to purchase the transaction target is stored in association with the user identification information, the determined reward information reception means receives coupon identification information identifying a coupon having been determined by the questioner as a coupon to be given, and the storage control means causes the storage means to store the coupon information as the reward information in association with the user identification information of the answerer, the coupon information as the reward information being identified by the received coupon identification information.

According to this invention, the answerer can obtain a coupon that can be used to purchase the transaction target. Therefore, it is possible to promote purchase of the transaction target.

An invention described in claim 6 is the question and answer processing device according to claim 5, further comprising: a coupon information transmission means that transmits one or more pairs of the coupon information and cost information which are stored in a coupon information storage means to the questioner terminal device, the coupon information storage means storing the coupon information and the cost information in association with each other, the cost information indicating a cost defrayed by the questioner to give a coupon, wherein the determined reward information reception means receives the coupon identification information of the coupon information selected by the questioner from the coupon information transmitted to the questioner terminal device.

According to this invention, the questioner can select a coupon as the reward to be given to the answerer after considering the cost defrayed by the questioner. Thus, the questioner can give a coupon with a value according to the content of the answer.

An invention described in claim 7 is the question and answer processing device according to claim 6, wherein the question information reception means receives rough estimate cost information as the rough estimate reward information, the rough estimate cost information indicating a rough estimate of a cost estimated by the questioner, the question and answer processing device further comprises a coupon information acquisition means that acquires the coupon information corresponding to a cost indicated by the received rough estimate cost information from the coupon information storage means, the question information transmission means transmits the received question information and the acquired coupon information to the answerer terminal device, and the coupon information transmission means transmits at least the acquired coupon information to the questioner terminal device.

According to this invention, as a rough estimate of the reward, the information of the coupon corresponding to the cost which the questioner think he or she will defray is presented to the user to be an answerer. Thus, the user can determine whether or not to provide an answer after checking the coupon that may be obtained if the user provides an answer.

An invention described in claim 8 is the question and answer processing device according to claim 6 or 7, wherein in the coupon information storage means, the coupon information and the cost information are stored in association with each other, the coupon information having been set by a provider providing the transaction target, the coupon information indicating that the coupon can be used to the provider having set the coupon information, the cost information having been set by the provider.

According to this invention, the provider of the transaction target sets a coupon which the provider may issue to the answerer, so that when the coupon is given to the answerer, a possibility occurs where the answerer purchases the transaction target from the provider by using the coupon. Thus, it is possible to promote the purchase of the transaction target provided by the provider which sets the coupon.

An invention described in claim 9 is the question and answer processing device according to claim 8, wherein in the coupon information storage means, the coupon information indicating content of discount of purchase price and the cost information indicating an amount of a cost corresponding to an amount of money smaller than an amount of money to be discounted by use of a coupon are stored in association with each other.

According to this invention, the questioner can give a coupon with a value higher than the value of the cost defrayed by the questioner to the answerer. Thus, it is possible to increase motivation for the user to provide an answer. Even when the provider of the transaction target defrays part of the cost to issue the coupon, the provider can promote the purchase of the transaction target provided by the provider.

An invention described in claim 10 is the question and answer processing device according to claim 8 or 9, wherein in the coupon information storage means, the coupon information indicating provider identification information identifying the provider having set a coupon and the cost information are stored in association with each other, and the coupon information transmission means transmits the coupon information including the provider identification information searched for by a provider identification information search means and the cost information corresponding to the coupon information to the questioner terminal device, the provider identification information search means searching for the provider identification information the provider identification information search means searching for the provider identification information of the provider to be recommended to a user indicated by the user identification information acquired by the acquisition means, the provider identification information search means searching for the provider identification information on the basis of personal information of a user, the personal information being registered according to an operation of the user on an electronic commerce site where the transaction target provided from the provider can be purchased.

According to this invention, the questioner can give a coupon issued by a provider suitable for the user to be an answerer to the answerer without an effort to search for a provider that issues a coupon on an electronic commerce site or the like.

An invention described in claim 11 is the question and answer processing device according to any one of claims 6 to 9, wherein in the coupon information storage means, the coupon information including transaction target identification information and the cost information are stored in association with each other, the transaction target identification information identifying a transaction target for which a coupon can be used, and the coupon information transmission means transmits the coupon information including the transaction target identification information searched for by a transaction target identification information search means and the cost information corresponding to the coupon information to the questioner terminal device, the transaction target identification information search means searching for the transaction target identification information of the transaction target to be recommended to a user indicated by the user identification information acquired by the acquisition means, the transaction target identification information search means searching for the transaction target identification information on the basis of personal information of a user, the personal information being registered according to an operation of the user on an electronic commerce site where the transaction target can be purchased.

According to this invention, the questioner can give a coupon of an item for sale suitable for the user to be an answerer to the answerer without an effort to search for the coupon on an electronic commerce site or the like.

An invention described in claim 12 is the question and answer processing device according to any one of claims 1 to 11, further comprising: an address information acquisition means that acquires address information of a user identified by the acquired user identification information; a generation means that generates display information on the basis of the acquired address information, the display information being used for displaying a map showing a distribution of users identified by the acquired user identification information; and a display information transmission means that transmits the generated display information to the questioner terminal device, wherein the question information reception means receives question information from the questioner terminal device having displayed the map based on the display information.

According to this invention, it is possible to present the information indicating where the users live who satisfy the purchase history requirements and the attribute requirements specified by the questioner in an easy-to-understand manner to the questioner. The questioner can ask a question after grasping the distribution of the users.

An invention described in claim 13 is the question and answer processing device according to claim 12, wherein the generation means generates the display information for displaying the map on which an object indicating a user identified by the acquired user identification information is arranged, the question information reception means receives the question information and the user identification information of a user indicated by the object selected by the questioner from the questioner terminal device having displayed the map on which the object is arranged based on the display information, and the question information transmission means transmits the received question information to the answerer terminal device used by a user identified by the user identification information received from the questioner terminal device.

According to this invention, the user indicated by the object selected on the map is the answerer. Therefore, the questioner can easily narrow down the area where the users to be answerers live and the number of the users while grasping the distribution of the users who satisfy the purchase history requirements and the attribute requirements.

An invention described in claim 14 is the question and answer processing device according to any one of claims 1 to 13, wherein in the storage means, the number of points held by a user as points being able to be used to purchase the transaction target is stored in association with the user identification information, the determined reward information reception means receives the number of points determined by the questioner as points to be given, and the storage control means subtracts the received number of points from the number of points stored in the storage means in association with the user identification information identifying the questioner and adds the received number of points to the number of points stored in the storage means in association with the user identification information of the answerer.

According to this invention, the answerer can obtain points that can be used to purchase the transaction target. Therefore, it is possible to promote purchase of the transaction target. Since the cost of the points to be given is defrayed by the questioner, it is possible to give an appropriate number of points to the answerer.

An invention described in claim 15 is the question and answer processing device according to any one of claims 1 to 14, wherein the question information reception means receives the purchase history requirement information including a requirement of a purchase period and the attribute requirement information including a requirement of an address.

According to this invention, the questioner can obtain an answer from users who purchased the transaction target in a specific period of time and live in a specific area.

An invention described in claim 16 is a question and answer processing method in a question and answer processing device to which terminal devices used by users to exchange questions and answers between users can be connected through a network, the question and answer processing method comprising: a question information reception step of receiving question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user; an acquisition step of acquiring user identification information having been searched for by a search means, the user identification information identifying a user, the search means searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information; a question information transmission step of transmitting the received question information to an answerer terminal device being the terminal device used by a user identified by the acquired user identification information; a determined reward information reception step of receiving determined reward information from the questioner terminal device having received answer information transmitted from the answerer terminal device, the determined reward information indicating a reward determined by a questioner for the answer information; and a storage control step of causing a storage means to store the received determined reward information in association with the user identification information of an answerer, the storage means storing information indicating things obtained by a user.

An invention described in claim 17 is a question and answer processing program that causes a computer included in a question and answer processing device to which terminal devices used by users to exchange questions and answers between users can be connected through a network to function as: a question information reception means that receives question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user; an acquisition means that acquires user identification information having been searched for by a search means, the user identification information identifying a user, the search means searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information; a question information transmission means that transmits the received question information to an answerer terminal device being the terminal device used by a user identified by the acquired user identification information; a determined reward information reception means that receives determined reward information from the questioner terminal device having received answer information transmitted from the answerer terminal device, the determined reward information indicating a reward determined by a questioner for the answer information; and a storage control means that causes a storage means to store the received determined reward information in association with the user identification information of an answerer, the storage means storing information indicating things obtained by a user.

An invention described in claim 18 is a recording medium in which a question and answer processing program is computer-readably recorded, the question and answer processing program causing a computer included in a question and answer processing device to which terminal devices used by users to exchange questions and answers between users can be connected through a network to function as: a question information reception means that receives question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user; an acquisition means that acquires user identification information having been searched for by a search means, the user identification information identifying a user, the search means searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information; a question information transmission means that transmits the received question information to an answerer terminal device being the terminal device used by a user identified by the acquired user identification information; a determined reward information reception means that receives determined reward information from the questioner terminal device having received answer information transmitted from the answerer terminal device, the determined reward information indicating a reward determined by a questioner for the answer information; and a storage control means that causes a storage means to store the received determined reward information in association with the user identification information of an answerer, the storage means storing information indicating things obtained by a user.

### Advantageous Effects of Invention

According to the present invention, a user who satisfies the purchase history requirements and the attribute requirements specified by the questioner is searched for as a user to be an answerer and the question information is transmitted to the terminal device used by the user who has been searched for. The questioner can determine the reward to the answerer after checking the answer information from the user who actually provides an answer. Therefore, it is possible to obtain a serious answer from a user who has a purchase history and an attribute desired by the questioner.

### BRIEF DESCRIPTION OF DRAWINGS

FIG. 1 is a diagram showing an example of a schematic configuration of a service providing system S according to an embodiment.

FIG. 2 is a diagram showing an example of content registered in the member information DB 1a according to the embodiment.

FIG. 3 is a block diagram showing an example of a schematic configuration of an online shopping mall server 2 according to the embodiment.

FIG. 4A is a diagram showing an example of content registered in a shop information DB 22a according to the embodiment. FIG. 4B is a diagram showing an example of content registered in an items-for-sale information DB 22b. FIG. 4C is a diagram showing an example of content registered in a favorite information DB 22c. FIG. 4D is a diagram showing an example of content registered in a browsing history DB 22d. FIG. 4E is a diagram showing an example of content registered in a purchase history DB 22e. FIG. 4F is a diagram showing an example of content registered in a shop coupon information DB 22f. FIG. 4G is a diagram showing an example of content registered in a user coupon information DB 22g.

FIG. 5 is a block diagram showing an example of a schematic configuration of a Q&A server 3 according to the embodiment.

FIG. 6A is a diagram showing an example of content registered in a Q&A information DB 32a according to the embodiment. FIG. 6B is a diagram showing an example of content included in questioner information. FIG. 6C is a diagram showing an example of content included in answerer information. FIG. 6D is a diagram showing an example of content registered in a map information DB 32b.

FIG. 7 is a sequence diagram showing an operation example of the service providing system S according to the embodiment.

FIG. 8 is a sequence diagram showing an operation example of the service providing system S according to the embodiment.

FIG. 9 is a screen display example of a question input page according to the embodiment.

FIG. 10 is a screen display example of a question input page according to the embodiment.

FIG. 11 is a screen display example of an answerer Q&A page according to the embodiment.

FIG. 12A is a screen display example of a reward history page according to the embodiment. FIG. 12B is a screen display example of a coupon information window.

FIG. 13 is a screen display example of a questioner Q&A page according to the embodiment.

FIG. 14 is a screen display example of a reward determination page according to the embodiment.

FIG. 15 is a flowchart showing a process example of an answerer candidate search request reception process of a system control unit 34 of the Q&A server 3 according to the embodiment.

FIG. 16 is a flowchart showing a process example of an answerer candidate search request reception process of a system control unit 24 of the online shopping mall server 2 according to the embodiment.

FIG. 17 is a flowchart showing a process example of a question registration request reception process of the system control unit 34 of the Q&A server 3 according to the embodiment.

FIG. 18 is a flowchart showing a process example of a reward determination page request reception process of the system control unit 34 of the Q&A server 3 according to the embodiment.

FIG. 19 is a flowchart showing a process example of a reward registration request reception process of the system control unit 34 of the Q&A server 3 according to the embodiment.

### DESCRIPTION OF EMBODIMENTS

Hereinafter, an embodiment of the present invention will be described in detail with reference to the drawings. The embodiment described below is an embodiment where the present invention is applied to a service providing system.

### 1. Schematic Configuration and Function of Service Providing System

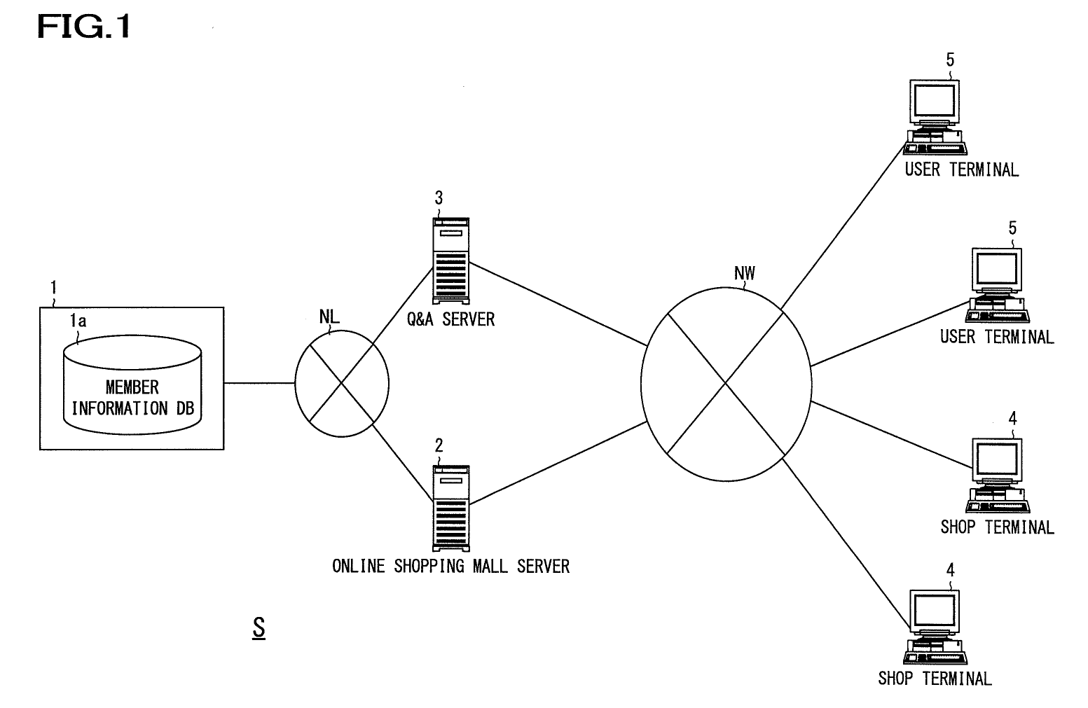

First, a schematic configuration and function of a service providing system S according to the embodiment will be described with reference to FIG. 1. FIG. 1 is a diagram showing an example of a schematic configuration of the service providing system S according to the embodiment.

As shown in FIG. 1, the service providing system S includes a database management server 1, an online shopping mall server 2, a Q&A server 3, a plurality of shop terminals 4, and a plurality of user terminals 5. The online shopping mall server 2, the Q&A server 3, the shop terminals 4, and the user terminals 5 can transmit and receive data to and from each other through a network NW by using, for example, TCP/IP as a communication protocol. The network NW includes, for example, the Internet, a dedicated communication line (for example, a CATV (Community Antenna Television) line), a mobile communication network (including a base station and the like), and gateways. The database management server 1, the online shopping mall server 2, and the Q&A server 3 can transmit and receive data to and from each other through a network NL. The network NL is, for example, a LAN (Local Area Network).

The database management server 1, the online shopping mall server 2, and the Q&A server 3 are, for example, servers that belong to a domain of a service providing site which is a Web site installed by a business operator to provide various services to users through a network. When a user is registered as a member of the service providing site, the user can use services of sites belonging to the service providing site.

The database management server 1 manages a database that registers information which is used in common by various server devices belonging to the domain of the service providing site. For example, the database management server 1 manages a member information DB (database) 1a which is a database of information related to members of the service providing site. In the embodiment, when the online shopping mall server 2 or the Q&A server 3 acquires information from the member information DB 1a, specifically, the online shopping mall server 2 or the Q&A server 3 transmits a request to the database management server 1 and receives the information registered in the member information DB 1a from the database management server 1.

The online shopping mall server 2 is a server device that performs various processes related to an online shopping mall belonging to the service providing site. In the online shopping mall (an example of an electronic commerce site in the present invention), a plurality of shops are open as venders that sell items for sale. Each shop (an example of a provider in the present invention) provides an item for sale purchased in the online shopping mall by sending the item for sale to a user or the like. A user can purchase a desired item for sale from a desired shop by using the online shopping mall. For example, the online shopping mall server 2 transmits a Web page of the online shopping mall and performs processes related to a search and a purchase of an item for sale according to a request from the user terminal 5.

The Q&A server 3 (an example of a question and answer processing device in the present invention) is a server device that performs various processes related to a Q&A site belonging to the service providing site. The Q&A site is a Web site for exchanging questions and answers between members through a network. On the Q&A site, a question and an answer to the question (hereinafter referred to as “Q&A”) are posted. A user can search for Q&A by a keyword search or the like and display a Q&A page on the user terminal 5. The Q&A page is a Web page on which specific Q&A information is displayed.

The Q&A site is a Web site mainly for a user to input a question related to an item for sale and a question related to a purchase of an item for sale. A questioner can specify requirements of users to be an answerer in order to obtain a credible answer to the question. There are main two types of information that is the requirements to be an answerer. The first information is a purchase history of an item for sale by a user in the online shopping mall. Items of requirements that can be specified as a purchase history of an item for sale are, for example, a purchased item for sale, a category to which the purchased item for sale belongs, a shop from which the item for sale is purchased, a purchase period, a purchase price, the number of the purchased items for sale, a delivery method, a settlement method, the frequency of the purchases, and the like. The second information is an attribute of a user. Items of requirements that can be specified as an attribute of a user are, for example, age, gender, address, and the like. A questioner specifies one or more requirements of the purchase history and one or more requirements of the attribute. Thereby, the questioner can narrow down users to be an answerer. In the Q&A site, only users who satisfy the requirements specified by the questioner can answer the question as an answerer. A user who satisfies the requirements specified by the questioner is referred to as an “answerer candidate”. A user who is actually requested to answer the question from the questioner is referred to as a “selected person”. Among the selected persons, a user who actually answers the question is an answerer.

In the Q&A site, in order to easily obtain a serious and sincere answer from the answerer, the questioner determines a reward given to the answerer after the questioner obtains the answer. As a reward to be given, there are points and a coupon that can be used in the online shopping mall. When the user purchases an item for sale, the points are assumed to have the same value as money and can be used as purchase money. In the embodiment, one point is assumed to be equivalent to one yen. The coupon is a virtual discount ticket that can discount the purchase price when the user purchases an item for sale in the online shopping mall. The coupon is issued from a shop. Basically, the coupon can be used only when the user purchases an item for sale from the shop which issued the coupon. Requirements of the item for sale which the coupon can be used for are specified.

First, when the questioner asks a question, the questioner inputs a rough estimate of the reward. The rough estimate of the reward is a level of the reward, which is estimated by the questioner, to be given to the user who provides an answer that satisfies the questioner. In other words, the questioner estimates the reward to be given in advance. The rough estimate of the reward is inputted as the number of points. The points are referred to as “rough estimate reward points”. Question information and the rough estimate of the reward are presented to the selected persons. The selected persons check the rough estimate of the reward, so that they can determine whether or not to provide an answer and what level of answer they provide.

Here, a coupon may be presented to the selected persons as the rough estimate of the reward. This coupon is referred to as a “rough estimate reward coupon”. The rough estimate reward coupon is, for example, a coupon which may be given to a user who provides an answer that satisfies the questioner. The rough estimate reward coupon is searched for by the Q&A server 3. The greater the number of the rough estimate reward points is, the higher the value of the rough estimate reward coupon is. The value of the coupon corresponds to an amount of money discounted (deducted) from the purchase price of an item for sale when the coupon is used. The value of the rough estimate reward coupon is set higher than the value of the rough estimate reward points. This is because the use of the coupon is limited (for example, items for sale and shops where the coupon can be used are limited) while the use of the points is not limited. When a coupon is actually given to an answerer, the coupon is issued from a shop. The cost (the issue cost) to issue the coupon is defrayed by the questioner and the shop. In other words, the questioner defrays part of the cost to give the coupon. The cost defrayed by the questioner is contributed from the points held by the questioner. The rough estimate reward coupon presented to the selected persons is a coupon that can be issued by the number of points indicated by the number of the rough estimate reward points. The questioner has an advantage that a coupon having a value higher than the number of points defrayed by the questioner can be given to the answerer. On the other hand, the shop that issues the coupon defrays part of the cost of the coupon. However, the shop has an advantage that an item for sale of this shop may be purchased by using the given coupon.

The rough estimate reward coupon is, for example, a coupon that can be used to purchase an item for sale which is registered in a favorite list by a selected person or a coupon that can be used in a shop which sells this item for sale. Items for sale registered in the favorite list are generally items for sale which the user wants to buy. When such a coupon is presented, it is expected that motivation of the selected persons to provide an answer is improved. The rough estimate reward coupon is, for example, a coupon that can be used to purchase an item for sale whose information has been browsed by a selected person before or a coupon that can be used in a shop which sells this item for sale. This is because the fact that the user has browsed the information indicates that the user may be interested in the item for sale or the shop. The rough estimate reward coupon is, for example, a coupon that can be used to purchase an item for sale which has been purchased by a selected person before or a coupon that can be used in a shop which sells this item for sale. This is because if the user likes the purchased item for sale, the user may purchase the item for sale again. Also, this is because if the user likes the shop from which the user purchased the item for sale, the user may purchase the item for sale from the shop again.

The questioner who receives an answer from an answerer determines a reward finally given to the answerer. The questioner determines the reward after receiving the answer, so that it is expected that the questioner can receive a serious answer from a selected person. Here, for example, the questioner may determine to give a reward to all answerers or may determine to give a reward to part of the answerers. The questioner may determine the reward regardless of the rough estimate of the reward inputted when the questioner asks a question. For example, the questioner may determine to give points, the number of which is the same as the number of the rough estimate reward points (an example of rough estimate reward information and rough estimate cost information), to an answerer who provides an answer that satisfies the questioner. The questioner may determine not to give a reward to an answerer who provides an answer that does not satisfy the questioner or may determine to give points, the number of which is smaller than the number of the rough estimate reward points, to the answerer. When the questioner determines that content of the answer is more than expected, the questioner may determine to give points, the number of which is greater than the number of the rough estimate reward points. The questioner may determine to give a coupon instead of giving points. At this time, a plurality of coupons may be presented to the questioner. The questioner can select a coupon to be given from the plurality of presented coupons. Here, the questioner may determine to give the same coupon as the rough estimate reward coupon or may determine to give a coupon other than the rough estimate reward coupon.

The rough estimate of the reward first presented to the selected persons may be different from the reward actually given to the answerer (particularly, the reward given to the answerer who provided an appropriate answer). Therefore, there is a possibility that the questioner deliberately sets the rough estimate of the reward to be high and sets the reward actually given to be low. In this case, a user who determines to provide an answer on the basis of the rough estimate of the reward has a disadvantage. Further, the presented rough estimate of the reward cannot be used as information for a user to make a decision whether or not to provide an answer. Therefore, on the Q&A site, it is possible to browse history of the rough estimates of the reward related to past questions asked by the questioner, content of answers provided from answerers, content of the rewards that are actually given, and the like. The selected persons can know whether or not the questioner is a user who gives a reward in accordance with the rough estimate of the reward and tendency of the answers preferred by the questioner by checking the history.

The shop terminal 4 (an example of a provider terminal device of the present invention) is a terminal device used by an employee or the like of a shop that is open in the online shopping mall. The shop terminal 4 accesses a server device such as the online shopping mall server 2 and the Q&A server 3 on the basis of an operation from a user. Thereby, the shop terminal 4 receives a Web page from the server device and displays the Web page. In the shop terminal 4, software such as a browser and an email client is installed. For example, the shop terminal 4 is used to register information of an item for sale to be sold and register information of a coupon that may be issued by the shop as a coupon given from the questioner to the answerer. For example, a personal computer or the like is used as the shop terminal 4.

The user terminal 5 (an example of a terminal device of the present invention) is a terminal device of a user who uses various Web sites. The user terminal 5 accesses a server device such as the online shopping mall server 2 and the Q&A server 3 on the basis of an operation from a user. Thereby, the user terminal 5 receives a Web page from the server device and displays the Web page. In the user terminal 5, software such as a browser and an email client is installed. For example, a personal computer, a PDA (Personal Digital Assistant), a mobile information terminal such as a smartphone, and a mobile phone are used as the user terminal 5.

### 2. Configurations of Each Server Device and Databases

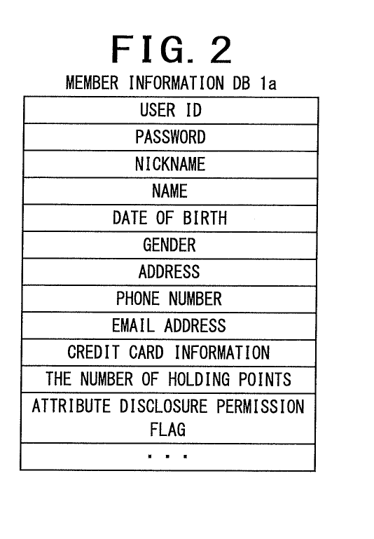

Next, configurations of each server and databases will be described with reference to FIGS. 2 to 6.

### 2-1. Configuration of Databases

FIG. 2 is a diagram showing an example of content registered in the member information DB 1a according to the embodiment. The database management server 1 includes a system control unit including a CPU (Central Processing Unit) and the like, a storage unit including a hard disk drive and the like, a communication unit, and the like. A member information DB 1a is constructed in the storage unit (an example of a storage means of the present invention) of the database management server 1.

In the member information DB 1a, member information related to users registered in the service providing site as a member is registered. Specifically, in the member information DB 1a, a user ID, a password, a nickname, a name, a date of birth, a gender, an address, a phone number, an email address, credit card information, the number of holding points, an attribute disclosure permission flag, and the like are registered in association with each user. The user ID (an example of user identification information of the present invention) is identification information of the user. The number of holding points (an example of information indicating things obtained by a user in the present invention) is the number of points held by the user.

The attribute disclosure permission flag indicates whether or not disclosure of the attribute of the user is permitted. In the Q&A site, the online shopping mall server 2 searches for users who satisfy requirements of an attribute specified by the questioner. At this time, information that may be specified as the requirements of the attribute includes an age corresponding to the date of birth, the gender, the address, and the like included in the member information. When a selected person provides an answer, the questioner knows that the selected person is a user who satisfies the requirements of the attribute specified by the questioner. The questioner inputs a question and sets requirements of the purchase history and requirements of the attribute on a question input page described later. On the question input page, a map showing a distribution of users satisfying the set requirements is displayed. The questioner can display the purchase history and the attribute of a user who satisfies the set requirements on the map. Thereby, personal information of a user may be known by another person. Therefore, each user can set whether or not to permit disclosure of the attribute of his or her own by him or herself. When the attribute disclosure permission flag is set to ON, it indicates that the disclosure of the attribute is permitted. On the other hand, when the attribute disclosure permission flag is set to OFF, it indicates that the disclosure of the attribute is not permitted.

### 2-2. Configuration of Online Shopping Mall Server

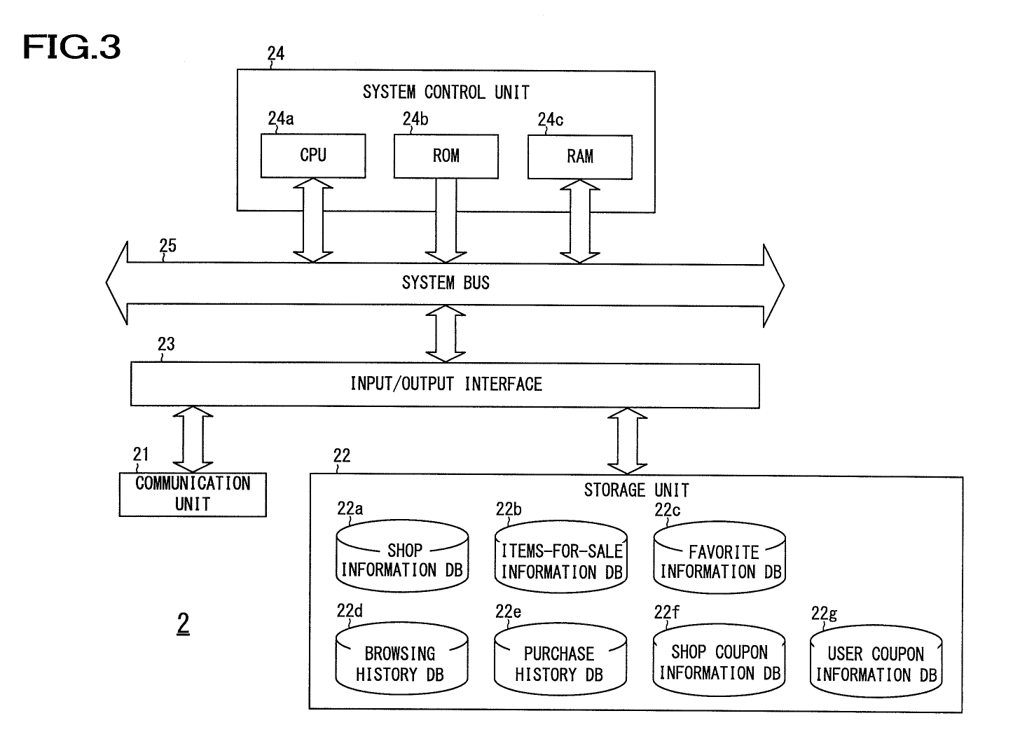

FIG. 3 is a block diagram showing an example of a schematic configuration of the online shopping mall server 2 according to the embodiment. As shown in FIG. 3, the online shopping mall server 2 includes a communication unit 21, a storage unit 22, an input/output interface 23, and a system control unit 24. The system control unit 24 and the input/output interface 23 are connected through a system bus 25.

The communication unit 21 connects to the networks NW and NL and controls communication state with the other servers, the shop terminals 4, the user terminals 5, and the like.

The storage unit 22 (an example of a storage means and a coupon information storage means of the present invention) includes, for example, a hard disk drive and the like. In the storage unit 22, databases such as a shop information DB 22a, an items-for-sale information DB 22b, a favorite information DB 22c, a browsing history DB 22d, a purchase history DB 22e, a shop coupon information DB 22f, and a user coupon information DB 22g are constructed.

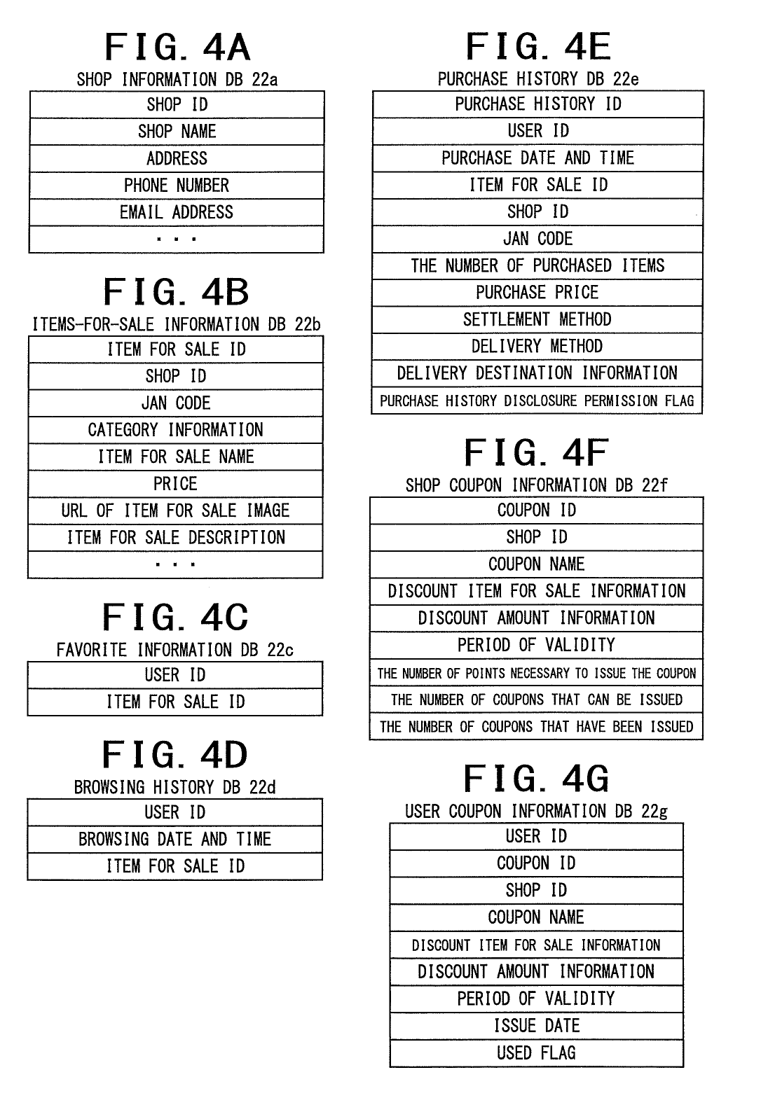

FIG. 4A is a diagram showing an example of content registered in the shop information DB 22a according to the embodiment. In the shop information DB 22a, shop information related to the shops that are open in the online shopping mall is registered. Specifically, in the shop information DB 22a, a shop ID, a shop name, an address, a phone number, an email address, and the like are registered in association with each shop. The shop ID (an example of provider identification information of the present invention) is identification information of a shop.

FIG. 4B is a diagram showing an example of content registered in the items-for-sale information DB 22b according to the embodiment. In the items-for-sale information DB 22b, items-for-sale information related to the items for sale sold in the online shopping mall is registered. Specifically, in the items-for-sale information DB 22b, an item for sale ID, a shop ID, a JAN code (Japanese Article Number Code), category information, an item for sale name, a price, a URL of item for sale image, an item for sale description, and the like are registered in association with each item for sale page. The item for sale page is a Web page on which item for sale information of a specific item for sale is displayed in the online shopping mall. The item for sale ID (an example of transaction target identification information of the present invention) is identification information of an item for sale. The item for sale ID corresponds to the item for sale page on a one-to-one basis. Therefore, a plurality of items for sale, which are actually the same item for sale but sold by different shops, are given item for sale IDs different from each other. The shop ID indicates a shop which sells the item for sale. The JAN code is a code number of the item for sale. The same JAN codes are given to the same items for sale. The category information is information indicating a category of an item for sale to which the item for sale belongs.

FIG. 4C is a diagram showing an example of content registered in the favorite information DB 22c according to the embodiment. In the favorite information DB 22c, favorite information (an example of personal information of the present invention) related to an item for sale registered by a user as a favorite. Specifically, in the favorite information DB 22c, a user ID and an item for sale ID are registered in association with each favorite item for sale. A favorite button is displayed on the item for sale page. When the user selects the favorite button, a registration request including an item for sale ID corresponding to the item for sale page is transmitted from the user terminal 5 to the online shopping mall server 2. The online shopping mall server 2 registers favorite information including the item for sale ID included in the received registration request and the user ID of the user who selected the favorite button into the favorite information DB 22c. Examples of items for sale which the user registers into the favorite include an item for sale that the user wants to buy, an item for sale that the user plans to buy, and the like. Also, there is a case in which the user likes the shop which sells the item for sale that the user registers in the favorite.

FIG. 4D is a diagram showing an example of content registered in the browsing history DB 22d according to the embodiment. In the browsing history DB 22d, a browsing history of item for sale pages by a user (an example of personal information of the present invention), that is, a display history of item for sale pages by the user terminal 5, is registered. Specifically, in the browsing history DB 22d, a user ID, a browsing date and time, and an item for sale ID are registered in association with each other. On a Web page in the online shopping mall, when a user selects an item for sale that the user wants to display, an item for sale page request including an item for sale ID of the selected item for sale is transmitted from the user terminal 5 to the online shopping mall server 2. The online shopping mall server 2 transmits an HTML document of an item for sale page corresponding to the item for sale ID included in the received item for sale page request to the user terminal 5. At this time, the online shopping mall server 2 registers a browsing history including the item for sale ID included in the item for sale page request and the user ID of the user who selected the item for sale into the browsing history DB 22d. In the favorite information DB 22c, for example, a shop ID of a shop that the user registers as a favorite may be registered.

FIG. 4E is a diagram showing an example of content registered in the purchase history DB 22e according to the embodiment. In the purchase history DB 22e, a purchase history of items for sale by a user (an example of personal information of the present invention) is registered. Specifically, in the purchase history DB 22e, a purchase history ID, a user ID, a purchase date and time, an item for sale ID, a shop ID, a JAN code, the number of purchased items, a purchase price, a settlement method, a delivery method, a delivery destination information, a purchase history disclosure permission flag, and the like are registered in association with each purchase of an item for sale. The purchase history ID is identification information of a purchase history. The user ID indicates a user who purchased the item for sale. The item for sale ID indicates a purchased item for sale. The shop ID indicates a shop from which the item for sale is purchased. The delivery destination information indicates an address, a name, a phone number, and the like of a delivery destination of the item for sale. The purchase history disclosure permission flag is information that is set because of the same reason as that for the attribute disclosure permission flag in the member information. Every time a user purchases an item for sale, the user can select whether or not to permit the disclosure of the purchase history registered at that time. On an order procedure page in the online shopping mall, when the user determines content of an order, an order request including an item for sale ID of an item for sale that the user orders is transmitted from the user terminal 5 to the online shopping mall server 2. The order procedure page is a Web page for the user to input information necessary for ordering the item for sale. The online shopping mall server 2 registers a purchase history including the item for sale ID included in the received order request, a shop ID corresponding to this item for sale ID, and a user ID of the user who determined the content of the order into the purchase history DB 22e.

The favorite information DB 22c, the browsing history DB 22d, and the purchase history DB 22e are databases into which personal information of a user is registered according to an operation of the user in the online shopping mall.

FIG. 4F is a diagram showing an example of content registered in the shop coupon information DB 22f according to the embodiment. In the shop coupon information DB 22f, shop coupon information indicating content of coupon that can be issued from the shop (an example of coupon information of the present invention) is registered. Specifically, in the shop coupon information DB 22f, a coupon ID, a shop ID, a coupon name, discount item for sale information, discount amount information, a period of validity, the number of points necessary to issue the coupon, the number of coupons that can be issued, the number of coupons that have been issued, and the like are registered in association with each coupon that can be issued.

The coupon ID (an example of coupon identification information of the present invention) is identification information of the coupon. The shop ID indicates a shop which issues the coupon. The coupon can be used only in the shop indicated by the shop ID. The discount item for sale information is information of an item for sale which the coupon can be used for. For example, the discount item for sale information is an item for sale ID of an item for sale which the coupon can be used for. In other words, the discount item for sale information indicates a specific item for sale which the coupon can be used for. Also, for example, the discount item for sale information indicates a lower limit of a purchase price of an item for sale which the coupon can be used for. For example, it is assumed that the discount item for sale information is set to 1000 yen. In this case, only when a user purchases an item for sale of 1000 yen or more, the user can use the coupon. The user can use the coupon for any item for sale whose price is higher than or equal to 1000 yen. The discount amount information is information indicating an amount of money discounted from a purchase price when the coupon is used. For example, the discount amount information may be information that directly indicates an amount of money discounted such as “discount of 100 yen”. Also, for example, the discount amount information may be information that indirectly indicates an amount of money discounted such as “discount of 10%”. The period of validity indicates a period in which the coupon can be used. For example, the period of validity indicates information such as “within three months from the issue date” and “until Dec. 31, 2011”. The number of points necessary to issue the coupon (an example of cost information of the present invention) indicates the number of points to be paid by the questioner to issue a coupon and give the coupon to the answerer. The number of coupons that can be issued indicates the number of coupons that can be issued for each predetermined period of time (for example, for each month). A coupon that is given to the answerer in the Q&A site is determined by the questioner regardless of the intension of the shop which issues the coupon. Therefore, the number of coupons that can be issued is set so that coupons, the number of which is beyond the expectation of the shop, are not issued. The number of coupons that have been issued is the number of coupons that have been actually issued in a predetermined period of time.

FIG. 4G is a diagram showing an example of content registered in the user coupon information DB 22g according to the embodiment. In the user coupon information DB 22g, user coupon information indicating content of coupon that is held by the user (an example of information indicating things obtained by a user and coupon information of the present invention) is registered. Specifically, in the user coupon information DB 22g, a user ID, a coupon ID, a shop ID, a coupon name, discount item for sale information, discount amount information, a period of validity, an issue date, a used flag, and the like are registered in association with each coupon held by the user. Information from the coupon ID to the period of validity is the same as that included in the shop coupon information. The issue date is a date on which the coupon is issued. The issue date of a coupon given to the answerer in the Q&A site is a date on which the coupon is given to the answerer. The used flag indicates whether or not the coupon has already been used. When the used flag is set to ON, it indicates that the coupon has already been used. On the other hand, when the used flag is set to OFF, it indicates that the coupon has not yet been used. The user can use only coupons whose used flag is set to OFF among coupons held by the user.

Next, other information stored in the storage unit 22 will be described. The storage unit 22 stores various data, which forms Web pages of the online shopping mall, such as HTML (Hyper Text Markup Language) documents, XML (Extensible Markup Language) documents, image data, text data, and electronic documents.

Also, the storage unit 22 stores various programs such as an operating system, a WWW (World Wide Web) server program, a DBMS (DataBase Management System), and an electronic commerce management program. The electronic commerce management program is a program for performing processes related to the online shopping mall, such as registering an item for sale, adding an item for sale to shopping cart, and ordering an item for sale. For example, the various programs may be acquired from another server device or the like through the network NW or may be recorded in a recording medium such as a DVD (Digital Versatile Disc) and read through a drive device.

The input/output interface 23 performs interface processing among the communication unit 21, the storage unit 22, and the system control unit 24.

The system control unit 24 includes a CPU 24a, a ROM (Read Only Memory) 24 b, a RAM (Random Access Memory) 24c, and the like. In the system control unit 24, the CPU 24a reads and executes various programs, so that the system control unit 24 functions as a search means, a provider identification information search means, a transaction target identification information search means, and the like of the present invention.

The online shopping mall server 2 may include a plurality of server devices. For example, a server device that performs processes related to the electronic commerce, a server device that transmits a Web page of the online shopping mall according to a request from the shop terminal 4 and the user terminal 5, a server device that manages database, and the like may be connected to each other by a LAN or the like.

### 2-3. Configuration of Q&A Server

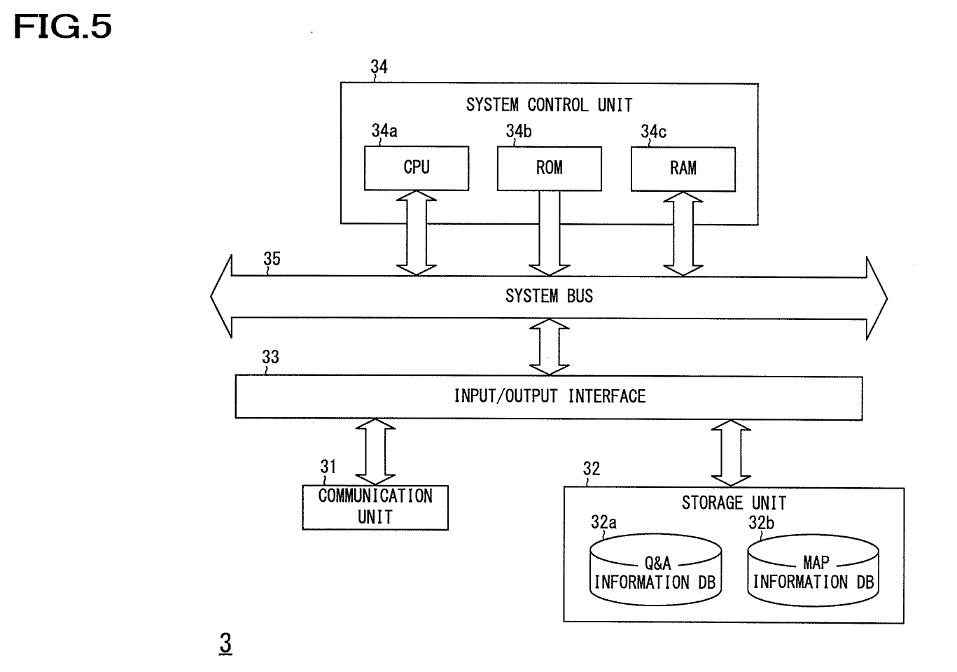

FIG. 5 is a block diagram showing an example of a schematic configuration of the Q&A server 3 according to the embodiment. As shown in FIG. 5, the Q&A server 3 includes a communication unit 31, a storage unit 32, an input/output interface 33, and a system control unit 34. The system control unit 34 and the input/output interface 33 are connected through a system bus 35.

The communication unit 31 connects to the networks NW and NL and controls communication state with the other servers, the user terminals 5, and the like.

The storage unit 32 (an example of a reward history information storage means of the present invention) includes, for example, a hard disk drive and the like. In the storage unit 32, databases such as a Q&A information DB 32a and a map information DB 32b are constructed.

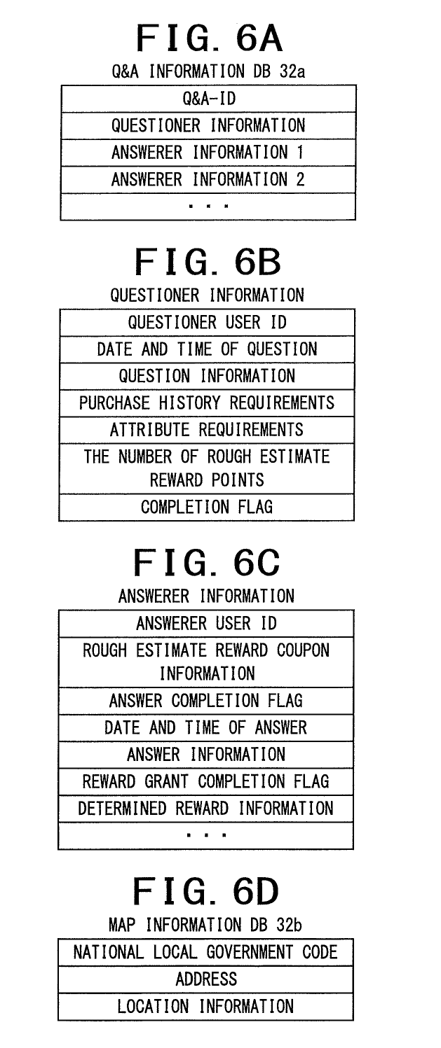

FIG. 6A is a diagram showing an example of content registered in the Q&A information DB 32a according to the embodiment. In the Q&A information DB 32a, Q&A information related to Q&A exchanged in the Q&A site (an example of reward history information of the present invention) is registered. Specifically, in the Q&A information DB 32a, a Q&A-ID, questioner information, and one or more pieces of answerer information are registered in association with each question. The Q&A-ID is identification information for identifying Q&A. The questioner information is information related to the questioner. The answerer information is information related to the selected persons and the answerers. One or more pieces of answerer information, the number of which is the number of users who become the selected persons, are registered.

FIG. 6B is a diagram showing an example of content included in the questioner information. In the questioner information, a questioner user ID, a date and time of the question, question information, one or more purchase history requirements, one or more attribute requirements, the number of the rough estimate reward points, and a completion flag are set. The questioner user ID is a user ID of the questioner. The question information is text information indicating content of the question.

The purchase history requirement indicates a requirement of purchase history specified by the questioner. Specifically, the purchase history requirement includes an item type and one or more item values. The item type is a type of an item of purchase history whose requirement is specified (for example, a purchased item for sale, a category to which the purchased item for sale belongs, a shop from which the item for sale is purchased, a purchase period, a purchase price, the number of the purchased items for sale, a settlement method, a delivery method, the frequency of the purchases, an address of delivery destination, and the like). The item value is a value indicating a requirement of the item indicated by the item type.

The attribute requirement indicates a requirement of attribute specified by the questioner. Specifically, the attribute requirement includes an attribute type and one or more attribute values. The attribute type is a type of an attribute whose requirement is specified (for example, an age, a gender, an address, and the like). The attribute value is a value indicating a requirement of the attribute indicated by the attribute type.

Basically, a conditional expression for searching for candidates of answerers is represented by a logical AND of all the purchase history requirements and all the attribute requirements. When a plurality of item values are set for one item in a purchase history requirement, or a plurality of attribute values are set for one attribute in an attribute requirement, the conditional expression for searching for candidates of answerers is represented by a logical OR of requirements indicated by the plurality of values. For example, it is assumed that requirements A1 and A2 are set as a requirement of the item for sale. Also, it is assumed that B is set as a requirement of the purchase period. Also, it is assumed that C is set as a requirement of the address of the user. In this case, the conditional expression is (A1+A2)*B*C. Here, “+” indicates logical OR and “*” indicates logical AND.

A Q&A completion flag indicates whether or not reception of answers is completed. For example, the selected persons can provide an answer in a period of time from when the question information is registered in the Q&A information DB 32a to when a predetermined period of time elapses. When the period of time has elapsed, the reception of answers is completed. When the Q&A completion flag is set to ON, it indicates that the reception of answers is completed. On the other hand, when the Q&A completion flag is set to OFF, it indicates that the reception of answers is not completed. The reception of answers may be completed by a completion operation from the questioner. The reception of answers may be completed when answers are obtained from users, the number of which is set by the questioner in advance.

FIG. 6C is a diagram showing an example of content included the answerer information. In the answerer information, an answerer user ID, rough estimate reward coupon information, an answer completion flag, a date and time of the answer, answer information, a reward grant completion flag, and determined reward information are included. The answerer user ID is a user ID of the selected person or the answerer. The rough estimate reward coupon information (an example of rough estimate reward information of the present invention) is information indicating content of the rough estimate reward coupon presented to the selected persons. Content of the rough estimate reward coupon information is basically the same as that of the shop coupon information. The answer information is text information indicating content of the answer. The reward grant completion flag indicates whether or not the reward is given from the questioner to the selected person or the answerer. When the reward grant completion flag is set to ON, it indicates that the reward is given. On the other hand, when the reward grant completion flag is set to OFF, it indicates that the reward is not given. The determined reward information indicates the reward given to the answerer. The determined reward information is set when the reward grant completion flag is changed from OFF to ON. When points are given to the answerer, the determined reward information indicates the number of the given points. When a coupon is given to the answerer, the determined reward information indicates the coupon ID of the given coupon.

FIG. 6D is a diagram showing an example of content registered in the map information DB 32b according to the embodiment. In the map information DE 32b, information related to geographical locations of municipalities is registered. Specifically, in the map information DB 32b, a national local government code, an address, and location information are registered. The national local government code is a code number assigned to the local government of the municipality. The address is the address of the municipality. The location information indicates, for example, the longitude and latitude at which the local government of the municipality is located. The map information DB 32b is used to display a distribution of users who satisfy the requirements set by the questioner in a map on the question input page. Information used for the distribution of the users is addresses of the users. In the map on the question input page, a figure representing a user is displayed at a position at which the municipality where the user lives is located. The figure is referred to as a “user object”.

Next, other information stored in the storage unit 32 will be described. The storage unit 32 stores various data, which forms Web pages of Q&A, such as HTML documents, XML documents, image data, text data, and electronic documents. Examples of the image data include image data of the map displayed on the question input page and image data of the user object.

Also, the storage unit 32 stores various programs such as an operating system, a WWW server program, a DBMS, a Q&A information management program, and an online shopping mall API (Application Program Interface). The Q&A information management program is a program for performing various processes related to the Q&A site. The online shopping mall API is a program provided from the online shopping mall. The online shopping mall API is a program for the Q&A server 3 to use various functions related to the online shopping mall of the online shopping mall server 2. For example, the system control unit 34 requests the online shopping mall 2 to search for answerer candidates and acquires the search result from the online shopping mall 2 by specifying the purchase history requirements, the attribute requirements, and the like and calling the online shopping mall API. The various programs (including an example of a question and answer processing program of the present invention) such as the Q&A information management program may be acquired from another server device or the like through the network NW or may be recorded in a recording medium such as a DVD and read through a drive device.

The input/output interface 33 performs interface processing among the communication unit 31, the storage unit 32, and the system control unit 34.

The system control unit 34 includes a CPU 34a, a ROM 34b, a RAM 34c, and the like. In the system control unit 34, the CPU 34a reads and executes various programs, so that the system control unit 34 functions as a question information reception means, an acquisition means, a question information transmission means, a determined reward information reception means, a storage control means, a reward history information transmission means, an answer information reception means, an answer information transmission means, a coupon information transmission means, a coupon information acquisition means, an address information acquisition means, a generation means, a display information transmission means, and the like of the present invention.

The Q&A server 3 may include a plurality of server devices. For example, a server device that processes question information and answer information, a server device that transmits a Web page of the Q&A site according to a request from the user terminal 5, a server device that transmits and receives emails, a server device that manages database, and the like may be connected to each other by a LAN or the like.

### 3. Operation of Service Providing System

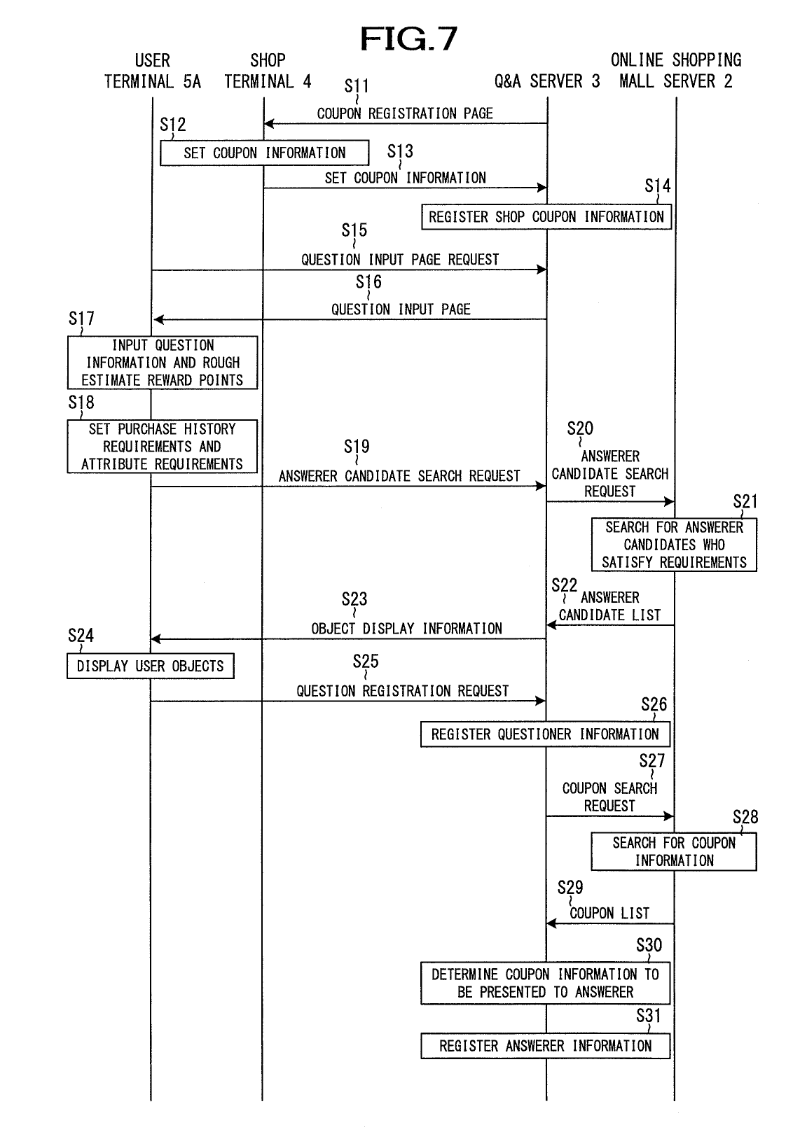

Next, an operation of the service providing system S will be described with reference to FIGS. 7 to 19.

### 3-1. Entire Operation

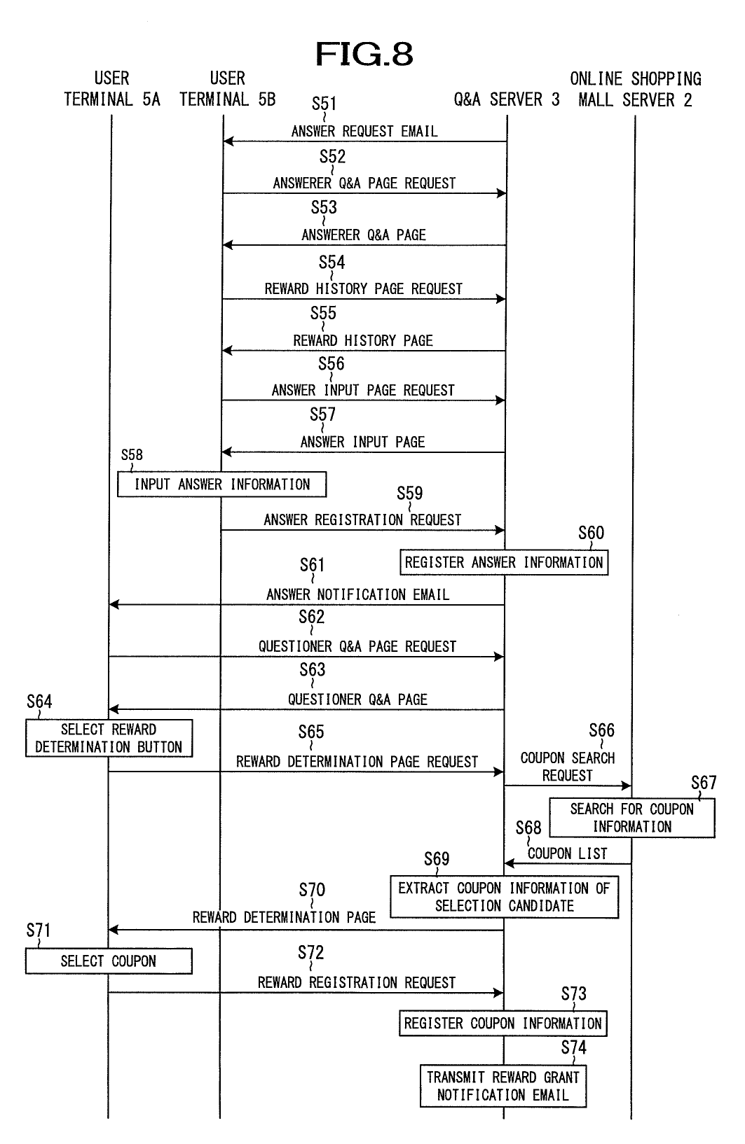

FIGS. 7 and 8 are sequence diagrams showing an operation example of the service providing system S according to the embodiment.

An employee or the like of a shop operates the shop terminal 4 to register a coupon that can be issued. Then, as shown in FIG. 7, the online shopping mall server 2 transmits an HTML document of a coupon registration page to the shop terminal 4 in response to a request from the shop terminal 4 (step S11).

The shop terminal 4 displays the coupon registration page based on the received HTML document. The coupon registration page is a Web page for setting content of the coupon. On the coupon registration page displayed on a screen, the employee or the like sets, for example, a coupon name, discount item for sale information indicating an item for sale ID of an item for sale to be discounted or a lower limit of the purchase price, discount amount information indicating an amount of money discounted or a discount rate, the number of points necessary to issue the coupon, a period of validity, the number of coupons that can be issued, and the like (step S12).

Here, the employee of the shop may set, for example, an item for sale which the employee wants to recommended to users or an item for sale for which the employee wants to promote sales as an item for sale for which the coupon can be used. For example, when the employee wants to increase the entire sales, the employee need not limit items for sale which the coupon can be used for. The employee may register a plurality of coupons which can be used for the same item for sale and whose number of points necessary to be issued is different from each other. By doing so, a certain range of the rough estimate reward points can be applied, so that the shop can increase the possibility that coupons of this shop is presented to the selected persons. Further, when the questioner determines a reward, the possibility that the questioner selects a coupon of this shop as the reward can be increased.

In the HTML document of the coupon registration page, a script is described which sets the number of points necessary to issue the coupon greater than or equal to one and smaller than the number of points corresponding to the value of the coupon. Specifically, the shop terminal 4 acquires the value of the coupon. For example, when an amount of money to be discounted is set, the amount of money is the value of the coupon. When a discount rate is set, a value obtained by multiplying the price of an item for sale to be discounted by the discount rate is the value of the coupon. For example, when the shop terminal 4 transmits a set item for sale ID to the online shopping mall server 2, the shop terminal 4 acquires the price of the item for sale from the online shopping mall server 2. When a lower limit of a purchase price to be discounted is set, a value obtained by multiplying the set lower limit by the discount rate is the value of the coupon. The shop terminal 4 prevents the number of points greater than or equal to the value of the coupon from being inputted. In other words, the online shopping mall server transmits an HTML document of a coupon registration page on which the number of points greater than or equal to the value of the coupon cannot be inputted.

When the employee or the like completes the setting of various information, the shop terminal 4 transmits set coupon information including the set information and the shop ID to the online shopping mall server 2 (step S13). When the online shopping mall server 2 receives the set coupon information, the online shopping mall server 2 generates a new coupon ID. Then, the online shopping mall server 2 registers shop coupon information including the set coupon information and the generated coupon ID into the shop coupon information DB 22f (step S14).

Thereafter, for example, a user A operates a user terminal 5A to log in to the Q&A site. For example, when the user A inputs a user ID and a password, the user terminal 5A transmits the inputted information to the Q&A server 3. The Q&A server 3 authenticates the user on the basis of the received information. When the authentication is successfully performed, the Q&A server 3 transmits, for example, the received user ID (the user ID may be encrypted) as a cookie to the user terminal 5A. Then, the user ID as a cookie is added to a request transmitted from the user terminal 5A thereafter. Therefore, the Q&A server 3 can acquire the user ID of the user who uses the user terminal 5A that transmits a request to the Q&A server 3. The user who uses the user terminal 5 that transmits the request is referred to as a “request user”.

After completing the authentication, the Q&A server 3 transmits, for example, an HTML document of my page to the user terminal 5A. The user terminal 5A displays my page based on the received HTML document. My page is a Web page on which information related to the request user in the Q&A site is displayed. Specifically, a list of Q&As in which the request user is the questioner is displayed on my page. Also, a list of Q&As in which the request user is the selected person or the answerer is displayed on my page. A question button is displayed on my page. The question button is a button to display the question input page.

Here, the user A selects the question button to ask a question. Then, the user terminal 5A transmits a question input page request to the Q&A server 3 (step S15). The Q&A server 3 transmits an HTML document of the question input page to the user terminal 5A in response to the question input page request (step S16). The Q&A server 3 also transmits image data of a map to the user terminal 5A. The user terminal 5A displays the question input page on the basis of the received HTML document and image data.

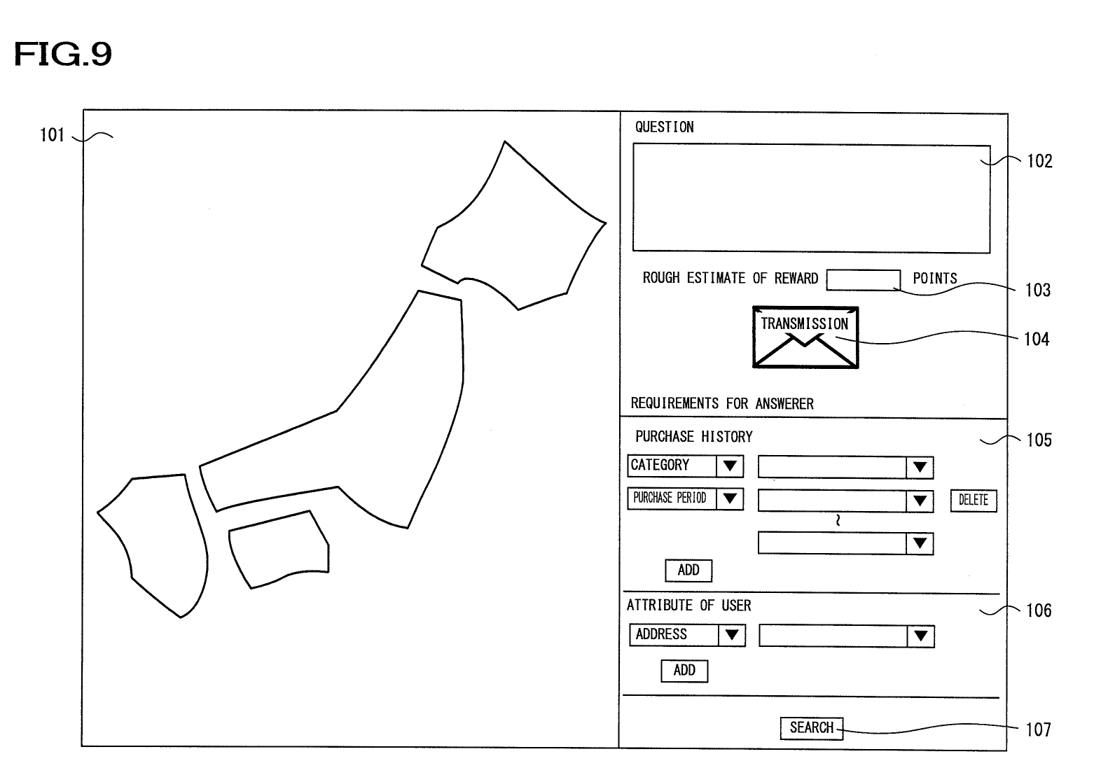

FIG. 9 is a screen display example of the question input page according to the embodiment. As shown in FIG. 9, on the question input page, a map 101, a question input field 102, the number of points input field 103, a question transmission icon 104, a purchase history requirement setting area 105, an attribute requirement setting area 106, and a search button 107 are displayed. The map 101 is, for example, a Japanese map. The question input field 102 is an input field for inputting question information. The number of points input field 103 is an input field for inputting the number of the rough estimate reward points. The question transmission icon 104 is an icon to transmit the question information to the Q&A server 3.

In the purchase history requirement setting area 105, various widgets for setting the purchase history requirements are displayed. Specifically, in the purchase history requirement setting area 105, a pull down menu for selecting an item to set a requirement, a pull down menu or an input field for selecting or inputting a requirement corresponding to the selected item, buttons, and the like are displayed. A user can increase or decrease the items to set a requirement by operating the buttons and the like.

In the attribute requirement setting area 106, various widgets for setting the attribute requirements are displayed. Specifically, in the attribute requirement setting area 106, a pull down menu for selecting an attribute to set a requirement, a pull down menu or an input field for selecting or inputting a requirement corresponding to the selected attribute, buttons, and the like are displayed. A user can increase or decrease the attributes to set a requirement by operating the buttons and the like.

Here, the user A inputs the question information and the rough estimate reward points (step S17). Also, the user A sets requirements of users to be an answerer (step S18). When setting a requirement, the user can select any item for the purchase history requirements. Also, the user can select any attribute for the attribute requirements. The user can select any number of requirements.

For example, it is assumed that the user A selects the category of an item for sale as an item of the purchase history and selects studless tires as a requirement of the category of an item for sale. Also, it is assumed that the user A selects the purchase period as an item of the purchase history and selects October to December 2010 as a requirement of the purchase period. Also, it is assumed that the user A selects the address as an attribute and selects Nagano Prefecture as a requirement of the address. Thereafter, the user A selects the search button 107. Then, the user terminal 5A transmits an answerer candidate search request including the set purchase history requirements and attribute requirement to the Q&A server 3 (step S19). In an input example by the user A, the answerer candidate search request includes a purchase history requirement where the item type is “category” and the item value is “studless tires”, a purchase history requirement where the item type is “purchase period” and the item value is “October to December 2010”, and an attribute requirement where the attribute type is “address” and the attribute value is “Nagano Prefecture”.

The Q&A server 3 transfers the received answerer candidate search request to the online shopping mall server 2 (step S20). As a search means, the online shopping mall server 2 searches for users who satisfy all the purchase history requirements and the attribute requirements included in the received answerer candidate search request (step S21). Then, the online shopping mall server 2 transmits an answerer candidate list, which is a list of user IDs of the users who have been searched for, to the Q&A server 3 (step S22). On the basis of the answerer candidate list, the Q&A server 3 generates object display information for displaying a distribution of the answerer candidates that have been searched for on a map. Then, the Q&A server 3 transmits the object display information to the user terminal 5A (step S23). Detailed contents of a process when the Q&A server 3 receives the answerer candidate search request and a process when the online shopping mall server 2 receives the answerer candidate search request will be described later as answerer candidate search request reception processes respectively.

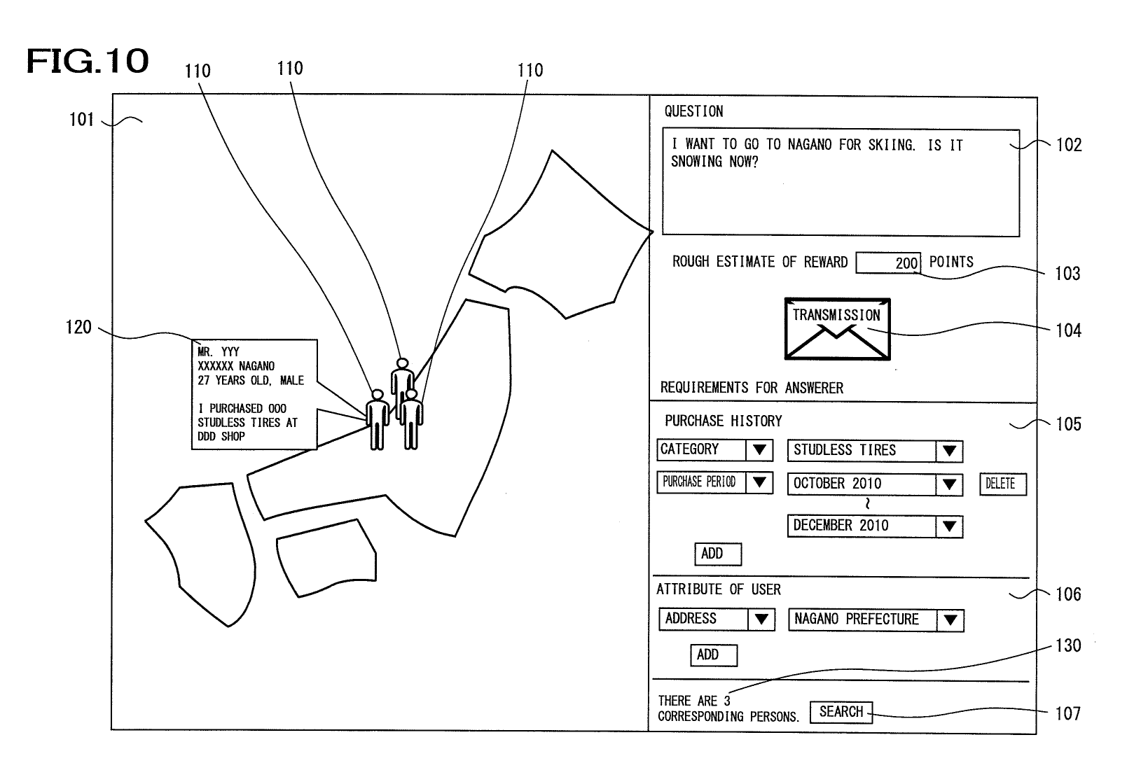

FIG. 10 is a screen display example of the question input page according to the embodiment. As shown in FIG. 10, the user terminal 5A displays the distribution of the answerer candidates, which have been searched for, on the question input page on the basis of the received object display information. Specifically, the user terminal 5A overlays and displays user objects 110, the number of which corresponds to the number of the answerer candidates that have been searched for, on the map 101 (step S24). A display position of a user object 110 corresponds to a location of a municipality that includes the address of an answerer candidate that has been searched for. In the requirement setting example by the user A described above, the user objects 110 indicating users who live in Nagano Prefecture and purchased studless tires between October and December 2010 are displayed at corresponding positions in Nagano Prefecture. By the displayed map 101 and the objects 110, the questioner can grasp at a glance where the users who satisfy the requirements live, what are areas where there are many users who satisfy the requirements, and a rough number of users who satisfy the requirements. On the question input page, the number of users who satisfy the requirements 130 is displayed.

The questioner can display a profile 120 on the question input page by selecting any one of the objects 110. In the profile 120, an attribute (nickname, address, age, gender, and the like) of the user corresponding to the selected object 110 and a purchase history (name of an item for sale, name of a shop from which the item for sale is purchased, and the like) whose disclosure is allowed by the user are displayed. When a user does not allow the disclosure of the attribute, the user is not searched for as an answerer candidate.

When the address is specified as an attribute requirement, a map of an area of the selected prefecture or the like may be enlarged and displayed and the user objects 110 may be displayed at positions corresponding to the enlarged map. A map of an area specified by the user may be enlarged and displayed according to an operation of the user.

Here, when the questioner is not satisfied by the search result of the answerer candidates, the questioner re-sets the purchase history requirements and the attribute requirements and selects the search button 107. Every time the search button 107 is selected, the process from step S19 to step S24 is performed. Or, the questioner re-sets the purchase history requirements and the attribute requirements and selects the question transmission icon 104. Then, the user terminal 5 transmits a question registration request including the inputted question information and rough estimate reward points, the new purchase history requirements, and the new attribute requirements to the Q&A server 3. In this case, the online shopping mall server 2 searches again for the answerer candidates with the new requirements. The answerer candidates that have been searched for at this time are determined as the selected persons.

On the other hand, when the questioner is satisfied by the search result of the answerer candidates, the questioner may select the question transmission icon 104. Then, the requirements that have been set are determined as the final requirements and the answerer candidates that have been searched for are fixed as the selected persons. In this case, the user terminal 5A transmits a question registration request including the inputted question information and rough estimate reward points and the purchase history requirements and the attribute requirements which are set first to the Q&A server 3. The questioner may select the question transmission icon 104 without selecting the search button 107 after selecting the purchase history requirements and the attribute requirements.

When the questioner wants to narrow down the area of the answerer candidates, the questioner may perform a range specifying operation on the map 101. Then, the answerer candidates corresponding to the objects 110 located in the specified range are selected as the selected persons. Or, for example, when the questioner positions the question transmission icon 104 at a desired position in the map 101 by a drag-and-drop operation, the answerer candidates corresponding to the objects 110 whose display positions are overlapped with the positioned question transmission icon 104 are selected as the selected persons. In these cases, the user terminal A determines a list of the user IDs of the selected answerer candidates as an answerer candidate list and transmits a question registration request including the question information, the rough estimate reward points, the purchase history requirements, the attribute requirements, and the answerer candidate list to the Q&A server 3.

Here, it is assumed that the user A does not re-set the requirements and selects the question transmission icon 104. Then, the user terminal 5A transmits a question registration request including the rough estimate reward points and the first set purchase history requirements and attribute requirements to the Q&A server 3 (step S25).

When the Q&A server 3, as a question information reception means, receives the question registration request, the Q&A server 3 registers Q&A information into the Q&A information DB 32a. First, the Q&A server 3 registers the questioner information on the basis of the question registration request (step S26). Next, the Q&A server 3 transmits a coupon search request including the user IDs included in the answerer candidate list received in step S22 to the online shopping mall server 2 (step S27). The online shopping mall server 2 searches for coupons of items for sale or shops to be recommended to the selected persons corresponding to the user IDs included in the coupon search request on the basis of the favorite information DB 22c, the browsing history DB 22d, and the purchase history DB 22e (step S28).

Specifically, the online shopping mall server 2, as a transaction target identification information search means, searches for favorite information corresponding to the user IDs from the favorite information DB 22c and acquires item for sale IDs from the favorite information. Next, the online shopping mall server 2, as a provider identification information search means, searches for item for sale information corresponding to the acquired item for sale IDs from the items-for-sale information DB 22b and acquires shop IDs and JAN codes from the item for sale information. Next, the online shopping mall server 2, as a transaction target identification information search means, searches for item for sale information including the acquired JAN codes and acquires item for sale IDs from the item for sale information that has been searched for. Next, the online shopping mall server 2 searches for shop coupon information including at least one of the item for sale IDs acquired from the favorite information, the shop IDs acquired from the item for sale information, and the item for sale IDs acquired from the item for sale information from the shop coupon information DB 22f. In other words, the online shopping mall server 2 searches for coupons of items for sale registered in the favorite by the selected persons, coupons issued from shops which sell these items for sale, and coupons of items for sale which are the same as the registered items for sale and which can be purchased from different shops. At this time, the online shopping mall server 2 excludes shop coupon information where the number of coupons that have been issued reaches the number of coupons that can be issued from the search target. The online shopping mall server 2 generates a favorite corresponding coupon list including the shop coupon information that has been searched for. The online shopping mall server 2 may perform the search by using only either the item for sale IDs or the shop IDs.

On the basis of the browsing history DB 22d, the online shopping mall server 2 searches for coupons of items for sale whose information is displayed on item for sale pages that the selected person has browsed, coupons issued from shops which sells the items for sale whose information is displayed, and coupons of items for sale which are the same as the items for sale whose information is displayed and which can be purchased from different shops. Specific processing content is basically the same as that of a case in which the search is performed on the basis of the favorite information DB 22c. The online shopping mall server 2 generates a browsing history corresponding coupon list including the shop coupon information that has been searched for.

On the basis of the purchase history DB 22e, the online shopping mall server 2 searches for coupons of items for sale which the selected person has purchased, coupons issued from shops which sell the purchased items for sale, and coupons of items for sale which are the same as the purchased items for sale and which can be purchased from different shop. Specific processing content is basically the same as that of a case in which the search is performed on the basis of the favorite information DB 22c. The online shopping mall server 2 generates a purchase history corresponding coupon list including the shop coupon information that has been searched for. When the online shopping mall server 2 searches for coupons based on the purchase history, the online shopping mall server 2 may search for coupons that can be used to purchase an item for sale related to an item for sale purchased by the selected person. This is because an item for sale related to an item for sale purchased by a user may be purchased by the user. For example, the related item for sale of a certain item for sale may be an optional item of the certain item for sale. Also, the related item for sale of a certain item for sale of contents such as a copyright product may be an item for sale of contents related to the contents. For example, the online shopping mall server 2 can search for related items for sale by including a database in which a JAN code of an item for sale and a JAN code of a related item for sale of the item for sale are registered in association with each other.

The online shopping mall server 2 transmits the generated coupon list to the Q&A server 3 (step S29). The Q&A server 3 determines rough estimate reward coupon information according to the rough estimate reward points from the shop coupon information included in the received coupon list (step S30). In other words, the Q&A server 3 determines a coupon to be presented to the selected person as a rough estimate of the reward. Next, the Q&A server 3 registers answerer information into the Q&A information DB 32a on the basis of the user ID of the selected person and the rough estimate reward coupon information (step S31). Detailed content of a process when the Q&A server 3 receives the question registration request will be described later as a question registration request reception process.

Next, as shown in FIG. 8, the Q&A server 3 transmits answer request emails directed to the respective selected persons (step S51). The answer request email is an email notifying that the selected person is requested to provide an answer. Here, it is assumed that an answer request email directed to a user B, who is the selected person, is transmitted. The user terminal 5B used by the user B receives the answer request email through an email server or the like and displays the answer request email. In a body text of the answer request email, for example, a message indicating that an answer is requested, a nickname of the questioner who requests the answer, question information, purchase history requirements, attribute requirements, the number of the rough estimate reward points, content of rough estimate reward coupon, an URL of an answerer Q&A page, and the like are described. The answerer Q&A page is a Q&A page for the selected person and the answerer. A Q&A-ID of a corresponding Q&A is added to the URL of the answerer Q&A page. The Q&A server 3 may include, for example, only the message indicating that an answer is requested in the body text of the answer request email.

When the user B selects the URL described in the body text of the answer request email, the user terminal 5B transmits an answerer Q&A page request including the selected URL (step S52). It is assumed that the user B has already logged in to the Q&A site. The Q&A server 3 acquires the Q&A-ID from the URL included in the answerer Q&A page request. Next, the Q&A server 3 acquires Q&A information corresponding to the acquired Q&A-ID from the Q&A information DB 32a. Next, the Q&A server 3 generates an HTML document of the answerer Q&A page based on the acquired Q&A information and the like. Then, as a question information transmission means, the Q&A server 3 transmits the generated HTML document to the user terminal 5B (step S53). The user terminal 5B displays the answerer Q&A page based on the received HTML document. The user can also display the answerer Q&A page by selecting an answer button corresponding to any Q&A from a list of Q&As where the user is the selected person on my page.

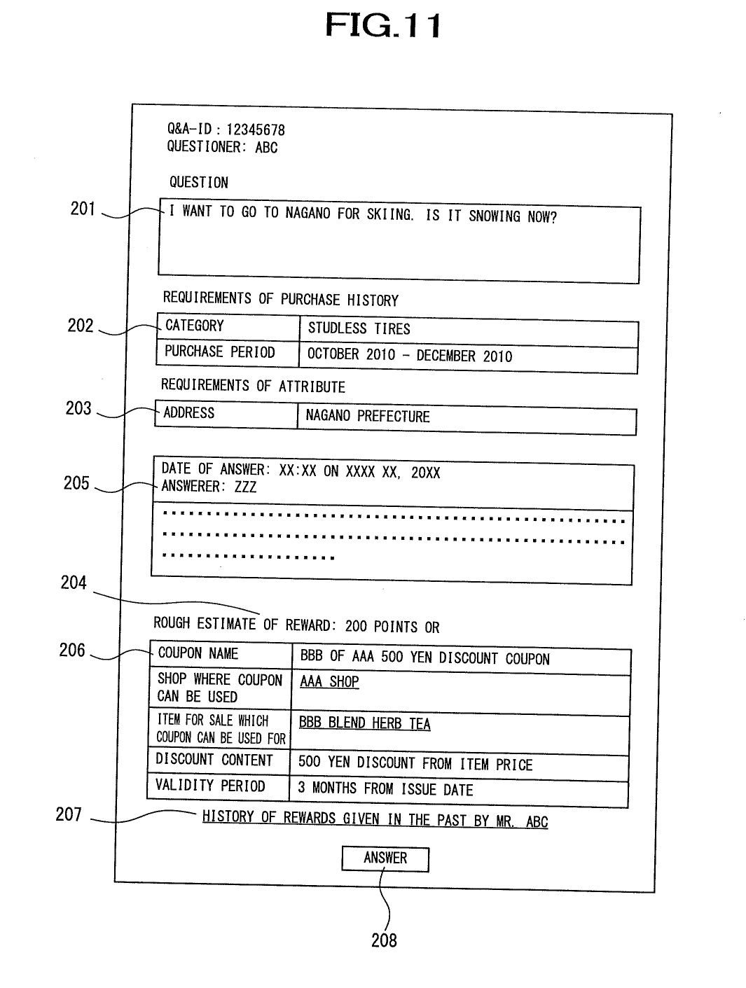

FIG. 11 is a screen display example of the answerer Q&A page according to the embodiment. As shown in FIG. 11, on the answerer Q&A page, question information 201, purchase history requirements 202, attribute requirements 203, and the number of the rough estimate reward points 204 are displayed. The question information 201 and the number of the rough estimate reward points 204 are the question information and the number of the rough estimate reward points which are inputted by the questioner. The purchase history requirements 202 and the attribute requirements 203 are the purchase history requirements and the attribute requirements which are set by the questioner. The user can check the reason why the user is selected as the selected person by seeing the purchase history requirements 202 and the attribute requirements 203. The purchase history requirements 202 and the attribute requirements 203 need not necessarily be displayed.

When at least one answer has already been provided from the selected persons, answer information 205 is displayed on the answerer Q&A page. In the answer information 205, a date of the answer, a nickname of the user who provided the answer, the answer information, and the like are displayed. On the answerer Q&A page, rough estimate reward coupon information 206 and a reward history link 207 are further displayed.

In the rough estimate reward coupon information 206, a coupon name of the coupon presented as a rough estimate of the reward, a shop name of a shop where the coupon can be used (a shop which issues the coupon), information of an item for sale which the coupon can be used for, information of an amount of money discounted from the price of an item for sale, a period of validity, and the like are displayed. When the user selects the shop name, a shop page of the shop indicated by the shop name is displayed on the screen. The shop page is a Web page on which information of a specific shop is displayed. When a name of an item for sale is displayed as the information of an item for sale which the coupon can be used for, if the user selects the name of the item for sale, an item for sale page of the item for sale indicated by the name of the item for sale is displayed.

The reward history link 207 is a link for displaying a reward history page. The reward history page is a Web page on which a history of the rough estimate of the reward set by the questioner and the reward which was actually given to the answerer for the Q&As which were asked by the questioner is displayed.

When the user does not yet provide an answer to the question information 201 displayed on the answerer Q&A page, an answer button 208 is further displayed on the answerer Q&A page. The answer button 208 is a button to display an answer input page. The answer input page is a Web page for inputting answer information. On the other hand, if the user has already provided an answer, the answer information 205 including the answer information inputted by the user is displayed on the answerer Q&A page.

On a Q&A page displayed to a user other than the questioner, the selected person, and the answerer, only the question information 201, the purchase history requirements 202, the attribute requirements 203, the number of the rough estimate reward points 204, and the answer information 205 are displayed. A questioner Q&A page will be described later.

Here, when the user B selects the reward history link 207, the user terminal 5B transmits a reward history page request including the user ID of the user A who is the questioner to the Q&A server 3 (step S54). The Q&A server 3 searches for Q&A information that includes the user ID included in the received reward history page request as the questioner user ID from the Q&A information DB 32a. At this time, the Q&A server 3 excludes Q&A information where the completion flag is set to OFF from the search target. When a coupon ID is included as the determined reward information in the answerer information included in the Q&A information that has been searched for, the Q&A server 3 acquires user coupon information corresponding to the answerer user ID and the coupon ID from the user coupon information DB 22g. At this time, the Q&A server 3 acquires the user coupon information through the online shopping mall server 2. Next, the Q&A server 3 generates an HTML document of the reward history page based on the Q&A information that has been searched for and the acquired user coupon information. Then, as a reward history information transmission means, the Q&A server 3 transmits the generated HTML document to the user terminal 5B (step S55). The user terminal 5B displays the reward history page based on the received HTML document.

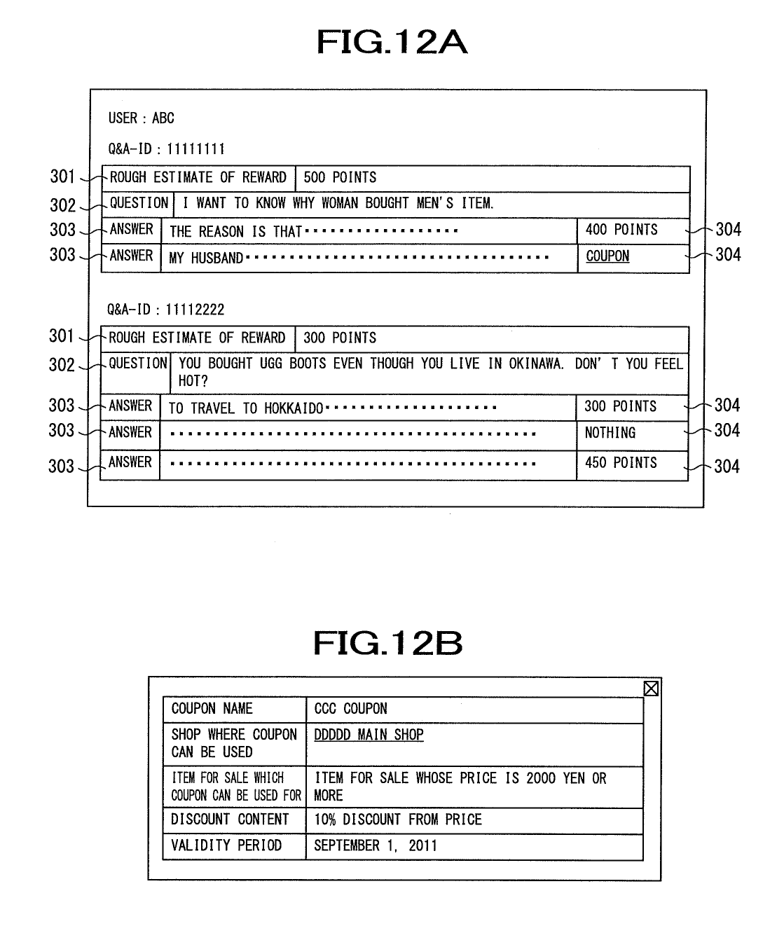

FIG. 12A is a screen display example of the reward history page according to the embodiment. As shown in FIG. 12A, on the reward history page, rough estimate reward points 301, question information 302, answer information 303, determined reward information 304, and the like are displayed for each Q&A that has been asked before by the questioner. The rough estimate reward points 301 and the question information 302 are the rough estimate reward points and the question information which are inputted by the questioner in the past Q&As. The answer information 303 and the determined reward information 304 are displayed in association with each other for each answer. The answer information 303 is answer information inputted by the answerer. The determined reward information 304 is content of the reward that was actually given to the answerer. When the given reward is points, the number of the points is displayed as the determined reward information 304. When the given reward is a coupon, a text of “coupon” is displayed as the determined reward information 304.

When the user selects the text of “coupon” displayed as the determined reward information 304, as shown in FIG. 12B, a coupon information window is overlaid and displayed on the reward history page. The coupon information window is a window in which content of a specific coupon and the like are displayed. Display content of the coupon information window is basically the same as the display content of the rough estimate reward coupon information 206. On the reward history page, at least the rough estimate reward points 301 and the determined reward information 304 need to be displayed in association with each other.

The user B redisplays the reward history page by operating the user terminal 5B. The user B has not yet provided an answer, so that the answer button 208 is displayed on the reward history page. Therefore, when the user B selects the answer button 208, the user terminal 5B transmits an answer input page request to the Q&A server 3 (step S56). The Q&A server 3 transmits an HTML document of the answer input page to the user terminal 5B in response to the answer input page request (step S57). The user terminal 5B displays the answer input page based on the received HTML document. Here, when the user B inputs answer information (step S58), the user terminal 5B transmits an answer registration request including the inputted answer information and a corresponding Q&A-ID to the Q&A server 3 (step S59).

The Q&A server 3 searches for Q&A information corresponding to the Q&A-ID included in the answer registration request received by the Q&A server 3 that is an answer information reception means from the Q&A information DB 32a. The Q&A server 3 acquires the user ID of the user B who is a request user on the basis of the answer registration request. Next, the Q&A server 3 searches for the answerer information corresponding to the acquired user ID from the Q&A information that has been searched for. Then, the Q&A server 3 additionally registers the answer information included in the answer registration request into the answerer information that has been searched for (step S60). The Q&A server 3 changes the answer completion flag included in the answerer information that has been searched for to ON. Next, as an answer information transmission means, the Q&A server 3 transmits an answer notification email directed to the user A who is the questioner (step S61). The answer notification email is an email notifying that an answer is provided to the questioner. The user terminal 5A receives the answer notification email through an email server or the like and displays the answer notification email. In a body text of the answer notification email, for example, a message indicating that an answer is provided, a nickname of the answerer, the answer information, a URL of a questioner Q&A page, and the like are described. The questioner Q&A page is a Q&A page for the questioner. A Q&A-ID of a corresponding Q&A is added to the URL of the questioner Q&A page. The Q&A server 3 may include, for example, only the message indicating that an answer is provided in the body text of the answer notification email.

When the user A selects the URL described in the body text of the answer notification email, the user terminal 5A transmits a questioner Q&A page request including the selected URL (step S62). The Q&A server 3 generates an HTML document of the questioner Q&A page based on the received questioner Q&A page request. Then, as an answer information transmission means, the Q&A server 3 transmits the generated HTML document to the user terminal 5A (step S63). The user terminal 5A displays the questioner Q&A page based on the received HTML document. The user can also display the questioner Q&A page by selecting any Q&A from a list of Q&As where the user is the questioner on my page.

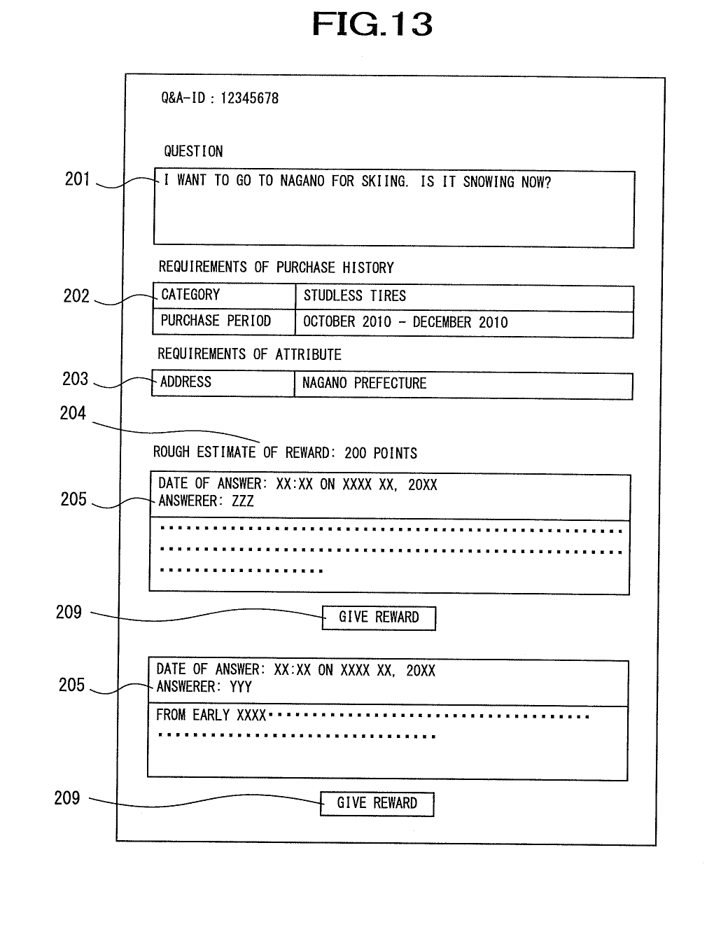

FIG. 13 is a screen display example of the questioner Q&A page according to the embodiment. In FIG. 13, the same components as those in FIG. 11 are denoted by the same reference numerals. As shown in FIG. 13, on the questioner Q&A page, question information 201, purchase history requirements 202, attribute requirements 203, and the number of the rough estimate reward points 204 are displayed. When at least one answer has already been provided from the selected persons, answer information 205 is displayed on the answerer Q&A page. Here, if the questioner does not determine the reward given to the answerer who provides the answer indicated by the answer information 205, a reward determination button 209 is displayed corresponding to the answer information 205. The reward determination button 209 is a button to display a reward determination page. The reward determination page is a Web page for determining content of the reward given to an answerer selected by the questioner. The reward determination button 209 may be displayed only when the reception of answers is completed. In other words, the rewards given to the answerers may be determined after the reception of answers is completed.

Here, when the user A selects the reward determination button 209 corresponding to the answer information 205 of the user B (step S64), the user terminal 5A transmits a reward determination page request including the user ID of the user B who is the answerer corresponding to the selected reward determination button 209 and a corresponding Q&A-ID (step S65).

The Q&A server 3 transmits a coupon search request including the user ID included in the received reward determination page request to the online shopping mall server 2 (step S66). The online shopping mall server 2 searches for shop coupon information of a coupon to be recommended to the selected person corresponding to the user ID included in the coupon search request (step S67). This process is the same as that of step S28. Then, the online shopping mall server 2 transmits a coupon list to the Q&A server 3 (step S68).

The Q&A server 3 extracts a plurality of pieces of shop coupon information to be a candidate given to the answerer from the shop coupon information included in the received coupon list (step S69). Next, the Q&A server 3 generates an HTML document of the reward determination page based on the extracted shop coupon information and the like. Then, the Q&A server 3 transmits the generated HTML document to the user terminal 5A (step S70). The user terminal 5A displays the reward determination page based on the received HTML document. Detailed content of a process when the Q&A server 3 receives the reward determination page request will be described later as a reward determination page request reception process.

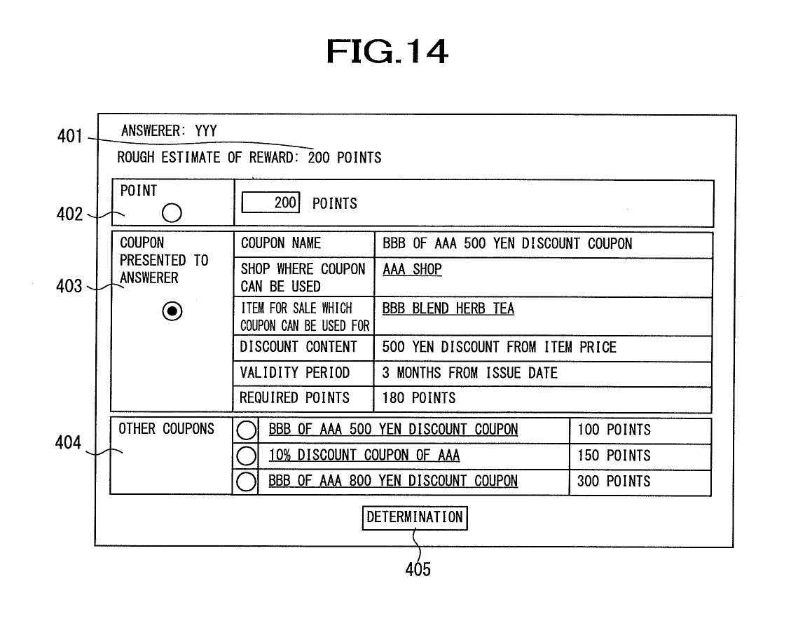

FIG. 14 is a screen display example of the reward determination page according to the embodiment. As shown in FIG. 14, on the reward determination page, the number of the rough estimate reward points 401, a point area 402, a rough estimate reward coupon area 403, an other coupons area 404, a determination button 405, and the like are displayed. The number of the rough estimate reward points 401 is the number of the rough estimate reward points which is inputted by the questioner when the questioner asks the question. In the point area 402, a radio button and an input field for inputting the number of points are displayed. In the rough estimate reward coupon area 403, a radio button, content of a coupon presented to the answerer as a rough estimate reward coupon, and the like are displayed. In the other coupons area 404, a list of coupons to be a selection candidate in addition to the rough estimate reward coupon is displayed. Specifically, a radio button, a coupon name, and the number of points necessary to issue the coupon are displayed for each coupon. The listed coupons are coupons related to the rough estimate reward coupon. For example, the listed coupons are coupons that can be used to purchase the same item for sale as an item for sale which the rough estimate reward coupon can be used for, coupons that are issued by a shop where the rough estimate reward coupon can be used, and the like. This is to prevent a coupon irrelevant to expectation of the answerer from being given to the answerer because the answerer provides an answer after seeing the content of the rough estimate reward coupon. The number of points necessary to issue these coupons is various. This is because the Q&A server 3 extracts coupons regardless of the number of the rough estimate reward points. Here, when the user selects a coupon name, the coupon information window shown FIG. 12B is overlaid and displayed on the reward determination page.

The user can select reward content by selecting any one of the radio buttons. For example, when the user selects the radio button in the point area 402, it is selected to give points. Then, the user can input the number of points to be given in the input field in the point area 402. When the user selects the radio button in the rough estimate reward coupon area 403, it is selected to give the rough estimate reward coupon. When the user selects anyone of the radio buttons in the other coupons area 404, it is selected to give a coupon corresponding to the radio button. The determination button 405 is a button to decide the reward content to be given. For example, the user may determine the content of the reward according to the content of the answer while considering the number of rough estimate reward coupons.

Here, it is assumed that the user A selects a radio button of any one of the coupons and selects the determination button 405 (step S71). Then, the user terminal 5A transmits a reward registration request including the coupon ID of the coupon corresponding to the selected radio button, the user ID of the user B who is the answerer, and a corresponding Q&A-ID to the Q&A server 3 (step S72). When the user selects the radio button in the point area 402, inputs the number of points, and selects the determination button 405, the user terminal 5 transmits a reward registration request including the inputted number of points, the user ID of the answerer, and a corresponding Q&A-ID.

The Q&A server 3 performs processes such as update of the Q&A information and registration of the user coupon information of the answerer to which a reward is given on the basis of the shop coupon information corresponding to the coupon ID included in the reward registration request received by the Q&A server 3 that is a determined reward information reception means (step S73). Then, the Q&A server 3 transmits a reward grant notification email directed the user B who is the answerer to whom the reward is given (step S74). The reward grant notification email is an email notifying the answerer that the reward is given. Detailed content of a process when the Q&A server 3 receives the reward registration request will be described later as a reward registration request reception process.

Next, an outline of the operation when the user purchases an item for sale by using points and a coupon held by the user will be described.

When the user terminal 5 displays an item for sale page, the user selects a purchase button displayed on the item for sale page. Then, the online shopping mall server 2 transmits an order procedure page to the user terminal 5 in response to a transmission from the user terminal 5. At this time, the online shopping mall server 2 acquires the number of holding points from the member information corresponding to the user ID of the request user. Also, the online shopping mall server 2 searches for coupons that can be used to purchase the item for sale from the user coupon information corresponding to the user ID of the request user. Specifically, the online shopping mall server 2 acquires the item for sale ID corresponding to the item for sale page and searches for user coupon information that includes the acquired item for sale ID. The online shopping mall server 2 acquires the shop ID from the item for sale information corresponding to the item for sale ID. Next, the online shopping mall server 2 searches for user coupon information which includes the acquired shop ID and in which no specific item for sale ID is included in the discount item for sale information. In other words, the online shopping mall server 2 searches for coupons that do not limit items for sale which the coupon can be used for from coupons issued from the shop that sells the item for sale whose information is displayed on the item for sale page. Then, the online shopping mall server 2 generates an HTML document of the order procedure page on the basis of the user coupon information that has been searched for and the like and transmits the HTML document to the user terminal 5.

The user terminal 5 displays the order procedure page based on the received HTML document. On the order procedure page, the user can select or input a settlement method, a delivery method, a delivery destination of the item for sale, and the like. Here, the user can input the number of points to be paid for the item for sale within a range smaller than or equal to the number of points held by the user. Also, the user can select a coupon to be used from coupons displayed on the order procedure page. When the user selects a decision button, the user terminal 5 transmits an order request including information according to the selection and the input from the user to the online shopping mall server 2. The online shopping mall server 2 performs processes such as a settlement of the purchase price on the basis of the received information. At this time, when the user uses points, the online shopping mall server 2 subtracts the number of points to be used from the number of points held by the user. Also, the online shopping mall server 2 performs the process of the settlement by deducting the amount of money corresponding to the points to be used from the purchase price. On the other hand, when the user uses a coupon, the online shopping mall server 2 performs the process of the settlement by deducting the amount of money corresponding to the discount amount information included in the user coupon information of the coupon to be used from the purchase price. The online shopping mall server 2 changes the used flag included in the corresponding user coupon information to ON. When completing the process of the settlement, the online shopping mall server 2 registers the purchase history into the purchase history DB 22e.

### 3-2. Operation of Server

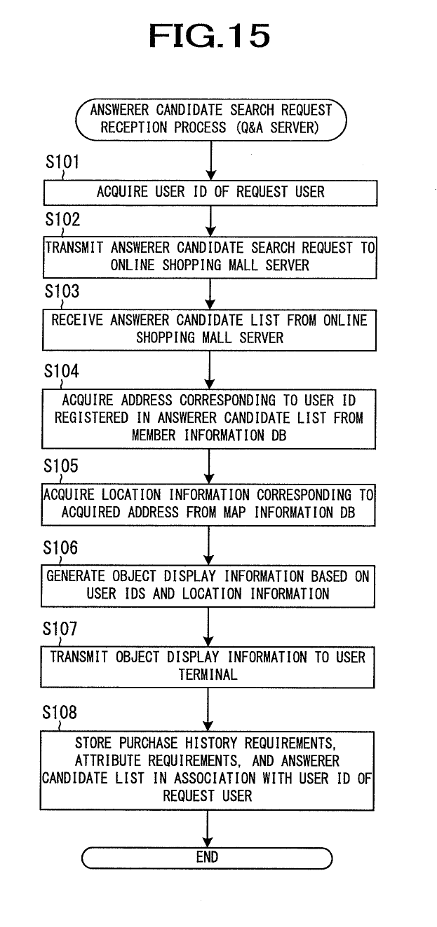

FIG. 15 is a flowchart showing a process example of the answerer candidate search request reception process of the system control unit 34 of the Q&A server 3 according to the embodiment.

As shown in FIG. 15, the system control unit 34 acquires the user ID of the request user on the basis of the answerer candidate search request received from the user terminal 5 (step S101). Next, the system control unit 34 transfers the received answerer candidate search request to the online shopping mall server 2 (step S102). Thereafter, as an acquisition means, the system control unit 34 receives the answerer candidate list transmitted from the online shopping mall server 2 (step S103).

Next, as an address information acquisition means, the system control unit 34 acquires an address corresponding to the user ID included in the received answerer candidate list from the member information DB 1a (step S104). Next, the system control unit 34 acquires location information corresponding to the acquired address from the map information DB 32b (step S105). The system control unit 34 performs the processes of steps S104 and S105 for each user ID included in the answerer candidate list.

Next, as a generation means, the system control unit 34 generates object display information based on the user IDs included in the answerer candidate list and the acquired location information (step S106). Specifically, the system control unit 34 converts the longitude and latitude indicated by the location information into the coordinates on the map 101 displayed on the question input page. The system control unit 34 generates the object display information in which each user ID included in the answerer candidate list is associated with the converted location information. The system control unit 34 includes the image data of the user object in the object display information.

Next, as a display information transmission means, the system control unit 34 transmits the generated object display information to the user terminal 5 that has transmitted the answerer candidate search request (step S107). The user terminal 5 can display the user object 110 on the map 101 on the basis of the location information included in the object display information. The user terminal 5 can acquire the user ID corresponding to the object 110 selected by the user by associating the user ID included in the object display information with the user object 110.

After transmitting the object display information, the system control unit 34 temporarily stores the purchase history requirements and the attribute requirements which are included in the received answerer candidate search request and the answerer candidate list received from the online shopping mall server 2 in the RAM 34c in association with the user ID of the request user (step S108). This is because to use the answerer candidate list, which is a search result using the purchase history requirements and the attribute requirements, if these requirements are not changed when the Q&A server 3 later receives a question registration request from the user terminal 5. The above process is performed assuming a case in which the user displays the search result of the answerer candidates as the user objects 110 by selecting the search button 107 on the question input page and then the user selects the question transmission icon 104 without changing the requirements. After completing the process of step S108, the system control unit 34 ends the answerer candidate search request reception process.

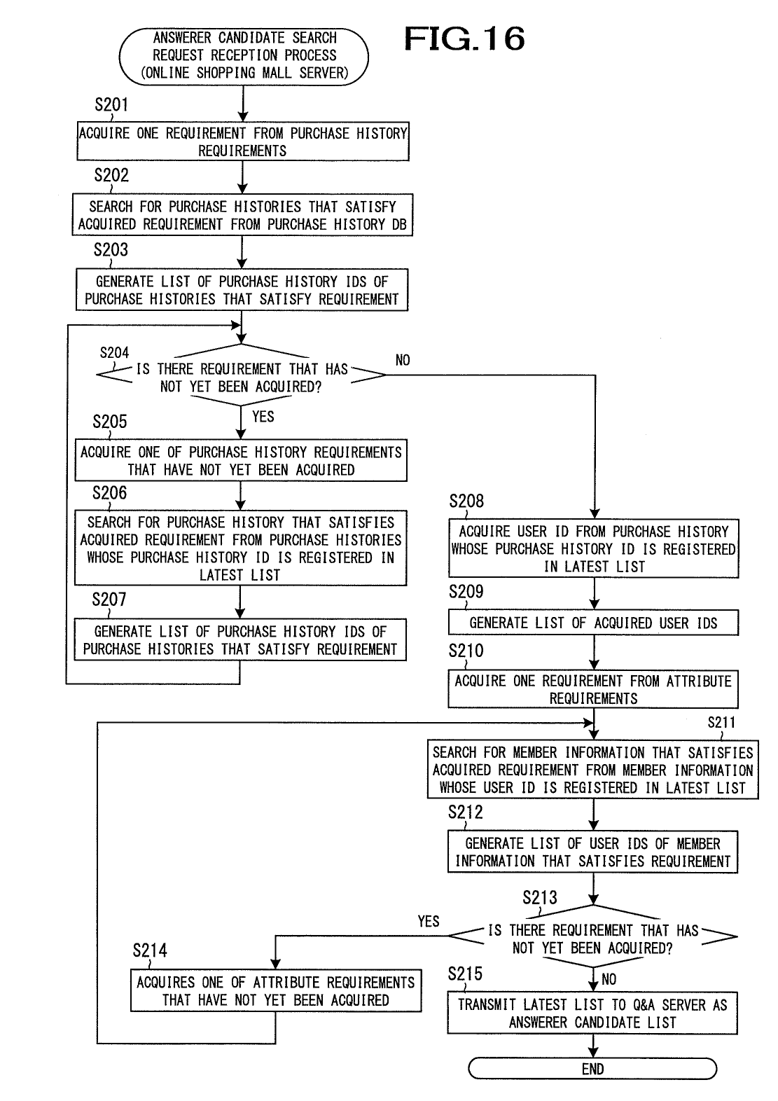

FIG. 16 is a flowchart showing a process example of the answerer candidate search request reception process of the system control unit 24 of the online shopping mall server 2 according to the embodiment.

As shown in FIG. 16, the system control unit 24 acquires one purchase history requirement from the purchase history requirements included in the answerer candidate search request received from the Q&A server 3 (step S201). Next, the system control unit 24 searches for purchase histories that satisfy the acquired purchase history requirement from the purchase history DB 22e (step S202). Specifically, the system control unit 24 searches for purchase histories in which information indicated by the item type included in the purchase history requirement satisfies a requirement indicated by the attribute value included in the purchase history requirement. At this time, the system control unit 24 excludes purchase histories where the purchase history disclosure permission flag is set to OFF from the search target. Next, the system control unit 24 generates a purchase history list which is a list of the purchase history IDs of purchase histories that satisfy the acquired purchase history requirement (step S203).

Next, the system control unit 24 determines whether or not there are one or more purchase history requirements that have not yet been acquired in the purchase history requirements included in the answerer candidate search request (step S204). At this time, if the system control unit 24 determines that there are one or more purchase history requirements that have not yet been acquired (step S204: YES), the system control unit 24 acquires one of the purchase history requirements that have not yet been acquired (step S205). Next, the system control unit 24 searches for purchase histories that satisfy the acquired purchase history requirement from purchase histories whose purchase history ID is registered in the latest purchase history list (step S206).

Next, the system control unit 24 generates a list of the purchase history IDs of the purchase histories that satisfy the acquired purchase history requirement as the latest purchase history list (step S207) and proceeds to step S204. The system control unit 24 repeats the process from step S204 to step S207, so that the system control unit 24 searches for purchase histories that satisfy all the purchase history requirements included in the answerer candidate search request. When the system control unit 24 determines that the system control unit 24 has acquired all the purchase history requirements (step S204: NO), the system control unit 24 proceeds to step S208.

In step S208, the system control unit 24 acquires a user ID from each purchase history whose purchase history ID is registered in the latest purchase history list (step S208). Next, the system control unit 24 generates a user list which is a list of the acquired user IDs (step S209). At this time, if there are the same user IDs, the system control unit 24 generates the user list so that there are not the same user IDs. Next, the system control unit 24 acquires one attribute requirement from the attribute requirements included in the answerer candidate search request (step S210). Next, the system control unit 24 searches for member information that satisfies the acquired attribute requirement in the member information registered in the member information DB 1a from member information of users whose user ID is registered in the latest user list (step S211). Specifically, the system control unit 24 searches for member information where information of an attribute indicated by the attribute type included in the attribute requirement satisfies a requirement indicated by the attribute value included in the attribute requirement. At this time, the system control unit 24 excludes member information where the attribute disclosure permission flag is set to OFF from the search target. Next, the system control unit 24 generates a list of user IDs of member information that satisfies the acquired attribute requirement as the latest user list (step S212).

Next, the system control unit 24 determines whether or not there are one or more attribute requirement that have not yet been acquired in the attribute requirements included in the answerer candidate search request (step S213). At this time, if the system control unit 24 determines that there are one or more attribute requirements that have not yet been acquired (step S213: YES), the system control unit 24 acquires one of the attribute requirements that have not yet been acquired (step S214) and proceeds to step S211. The system control unit 24 repeats the process from step S211 to step S214, so that the system control unit 24 searches for user IDs of users who satisfy all the attribute requirements included in the answerer candidate search request. When the system control unit 24 determines that the system control unit 24 has acquired all the attribute requirements (step S214: NO), the system control unit 24 transmits the latest user list to the Q&A server 3 as the answerer candidate list (step S215). After completing the process of step S215, the system control unit 24 ends the answerer candidate search request reception process.

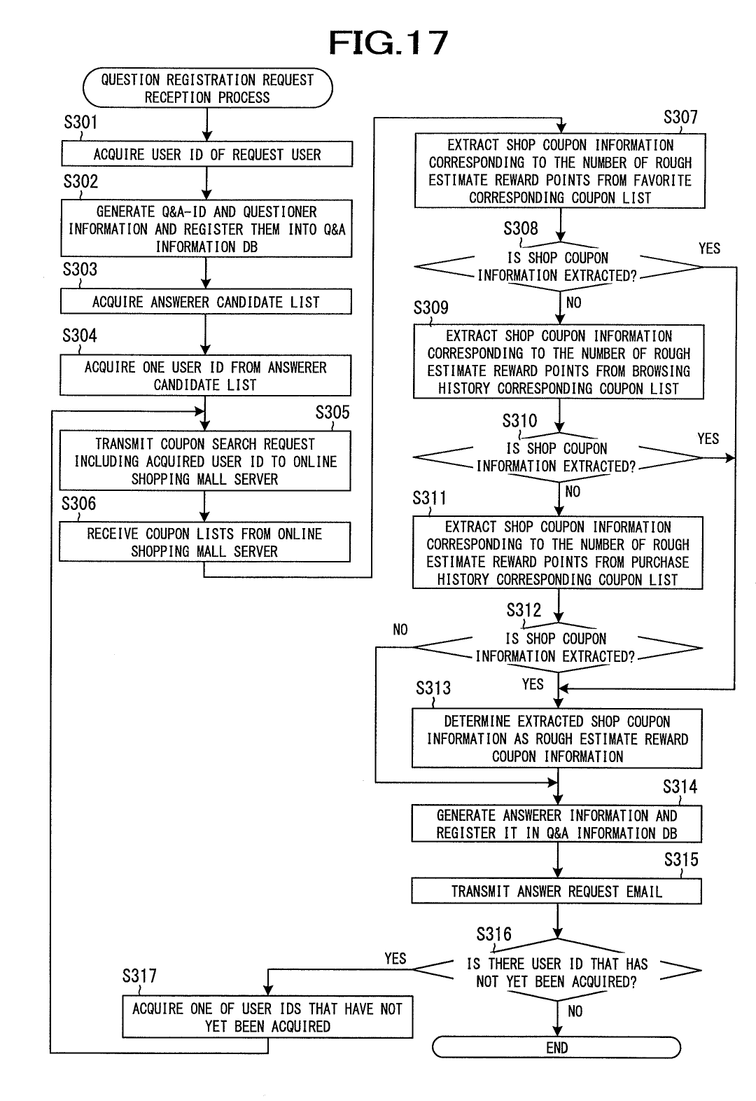

FIG. 17 is a flowchart showing a process example of the question registration request reception process of the system control unit 34 of the Q&A server 3 according to the embodiment.

As shown in FIG. 17, the system control unit 34 acquires the user ID of the request user on the basis of the question registration request received from the user terminal 5 (step S301). Next, the system control unit 34 generates a new Q&A-ID. The system control unit 34 generates questioner information including the user ID of the request user and information included in the question registration request. Next, the system control unit 34 registers Q&A information including the generated Q&A-ID and questioner information into the Q&A information DB 32a (step S302).

Next, the system control unit 34 acquires the answerer candidate list (step S303). Specifically, when the answerer candidate list is included in the question registration request, the system control unit 34 acquires the answerer candidate list from the question registration request. This is a case in which one or more user objects 110 of the answerer candidates are selected by a user operation on the question input page. On the other hand, when the answerer candidate list is not included in the question registration request, the system control unit 34 acquires the purchase history requirements and the attribute requirements corresponding to the user ID of the request user from the RAM 34c. Next, the system control unit 34 compares the purchase history requirements and the attribute requirements acquired from the RAM 34c with the purchase history requirements and the attribute requirements included in the question registration request. Next, when all the requirements correspond to each other, the system control unit 34 acquires the answerer candidate list corresponding to the user ID of the request user from the RAM 34c. This is a case in which the answerer candidates are searched for by selecting the search button 107 on the question input page and then the question transmission icon 104 is selected without changing the purchase history requirements and the attribute requirements. On the other hand, when one or more requirements do not correspond to each other, the system control unit 34 transmits an answerer candidate search request including the purchase history requirements and the attribute requirements included in the question registration request to the online shopping mall server 2. Thereby, as an acquisition means, the system control unit 34 acquires an answerer candidate list from the online shopping mall server 2. This is a case in which the answerer candidates are searched for and thereafter the purchase history requirements and the attribute requirements are changed. When, in the first place, the answerer candidate list corresponding to the user ID of the request user is not stored in the RAM 34c, the system control unit 34 acquires the answerer candidate list by transmitting an answerer candidate search request. This is a case in which the question transmission icon 104 is selected without selecting the search button 107.

Next, the system control unit 34 acquires one user ID from the answerer candidate list (step S304). Next, the system control unit 34 transmits a coupon search request including the acquired user ID to the online shopping mall server 2 (step S305). Thereafter, as a coupon information acquisition means, the system control unit 34 receives a favorite corresponding coupon list, a browsing history corresponding coupon list, a purchase history corresponding coupon list, which are transmitted from the online shopping mall server 2 (step S306).

Next, as a coupon information acquisition means, the system control unit 34 determines a rough estimate reward coupon to be presented to the selected persons on the basis of the received coupon list. Here, the system control unit 34 preferentially determines the rough estimate reward coupon from coupons whose shop coupon information is registered in the favorite corresponding coupon list. This is because the items for sale registered in the favorite are highly probably items for sale the user wants to buy more than items for sale whose information has been browsed by the user and items for sale which have been purchased by the user. The system control unit 34 tries to extract shop coupon information corresponding to the number of the rough estimate reward points included in the question registration request from shop coupon information registered in the favorite corresponding coupon list (step S307). Next, the system control unit 34 determines whether or not the shop coupon information corresponding to the number of the rough estimate reward points is extracted (step S308).

Specifically, the system control unit 34 searches for shop coupon information, whose number of points necessary to issue the coupon is smaller than or equal to the number of the rough estimate reward points, from the favorite corresponding coupon list. At this time, if there is no shop coupon information whose number of points necessary to issue the coupon is smaller than or equal to the number of the rough estimate reward points, the system control unit 34 determines that the shop coupon information corresponding to the number of the rough estimate reward points is not extracted. On the other hand, if there is shop coupon information whose number of points necessary to issue the coupon is smaller than or equal to the number of the rough estimate reward points, the system control unit 34 specifies shop coupon information whose number of points necessary to issue the coupon is the greatest from the shop coupon information that has been searched for. In other words, the system control unit 34 specifies shop coupon information whose number of points necessary to issue the coupon is nearest to the number of the rough estimate reward points as a candidate of the rough estimate reward coupon information. Next, the system control unit 34 determines whether or not the number of points corresponding to the amount of money to be discounted is greater than the number of the rough estimate reward points. In other words, the system control unit 34 determines whether or not the value of the candidate of the rough estimate reward coupon is higher than the value of the rough estimate of the reward by the questioner. At this time, when the number of points corresponding to the amount of money to be discounted is greater than the number of the rough estimate reward points, the system control unit 34 determines that the shop coupon information corresponding to the number of the rough estimate reward points is extracted. On the other hand, when the number of points corresponding to the amount of money to be discounted is smaller than or equal to the number of the rough estimate reward points, the system control unit 34 determines that no shop coupon information corresponding to the number of the rough estimate reward points is extracted.

When the system control unit 34 determines that no shop coupon information corresponding to the number of the rough estimate reward points is extracted (step S308: NO), the system control unit 34 tries to extract shop coupon information corresponding to the number of the rough estimate reward points included in the question registration request from shop coupon information registered in the browsing history corresponding coupon list (step S309). This is because the items for sale whose information has been browsed by the user are highly probably items for sale the user wants to buy more than items for sale which have been purchased by the user. Next, the system control unit 34 determines whether or not the shop coupon information corresponding to the number of the rough estimate reward points is extracted (step S310). Specific content of the process of steps S309 and S310 is basically the same as that of steps S307 and S308.

At this time, if the system control unit 34 determines that no shop coupon information corresponding to the number of the rough estimate reward points is extracted (step S310: NO), the system control unit 34 tries to extract shop coupon information corresponding to the number of the rough estimate reward points included in the question registration request from shop coupon information registered in the purchase history corresponding coupon list (step S311). Next, the system control unit 34 determines whether or not the shop coupon information corresponding to the number of the rough estimate reward points is extracted (step S312). Specific content of the process of steps S311 and S312 is basically the same as that of steps S307 and S308.

The priority of the coupon lists to be searched may be other than the priority described above. Only a part of the three coupon lists described above may be a coupon list to be searched.

In any one of steps S308, S310, and S312, if it is determined that the shop coupon information corresponding to the number of the rough estimate reward points is extracted (step S308: YES, step S310: YES, or step S312: YES), the user determines the extracted shop coupon information as the rough estimate reward coupon information (step S313).

Next, the system control unit 34 generates the answerer information. Specifically, the system control unit 34 generates the answerer information including the user ID acquired from the answerer candidate list and the rough estimate reward coupon information. At this time, the system control unit 34 sets both the answer completion flag and the reward grant completion flag to OFF. Then, the system control unit 34 additionally registers the generated answerer information into the questioner information registered in step S302 (step S314). If the system control unit 34 determines that no shop coupon information corresponding to the number of the rough estimate reward points is extracted in step S312 (step S312: NO), the system control unit 34 additionally registers the answerer information that does not include the rough estimate reward coupon information (step S314). In this case, the rough estimate reward coupon information 206 is not displayed on the answerer Q&A page.

Next, as a question information transmission means, the system control unit 34 transmits an answer request email (step S315). Specifically, the system control unit 34 generates an answer request email including question information, purchase history requirements, attribute requirements, the number of the rough estimate reward points, content of the rough estimate reward coupon, URL of the answerer Q&A page, and the like in its body text. Next, the system control unit 34 acquires an email address from member information corresponding to the user ID acquired from the answerer candidate list. Next, the system control unit 34 sets the acquired email address to a destination address of the answer request email. Then, the system control unit 34 transmits the generated answer request email.

Next, the system control unit 34 determines whether or not there are one or more user IDs that have not yet been acquired in the user IDs included in the answerer candidate list (step S316). At this time, if the system control unit 34 determines that there are one or more user IDs that have not yet been acquired (step S316: YES), the system control unit 34 acquires one of the user IDs that have not yet been acquired (step S317) and proceeds to step S305. The system control unit 34 repeats the process from step S305 to step S317, so that the system control unit 34 registers the answerer information and transmits the answer request email for all the selected persons. When the system control unit 34 determines that the system control unit 34 has acquired all the user IDs (step S316: NO), the system control unit 34 ends the question registration request reception process.

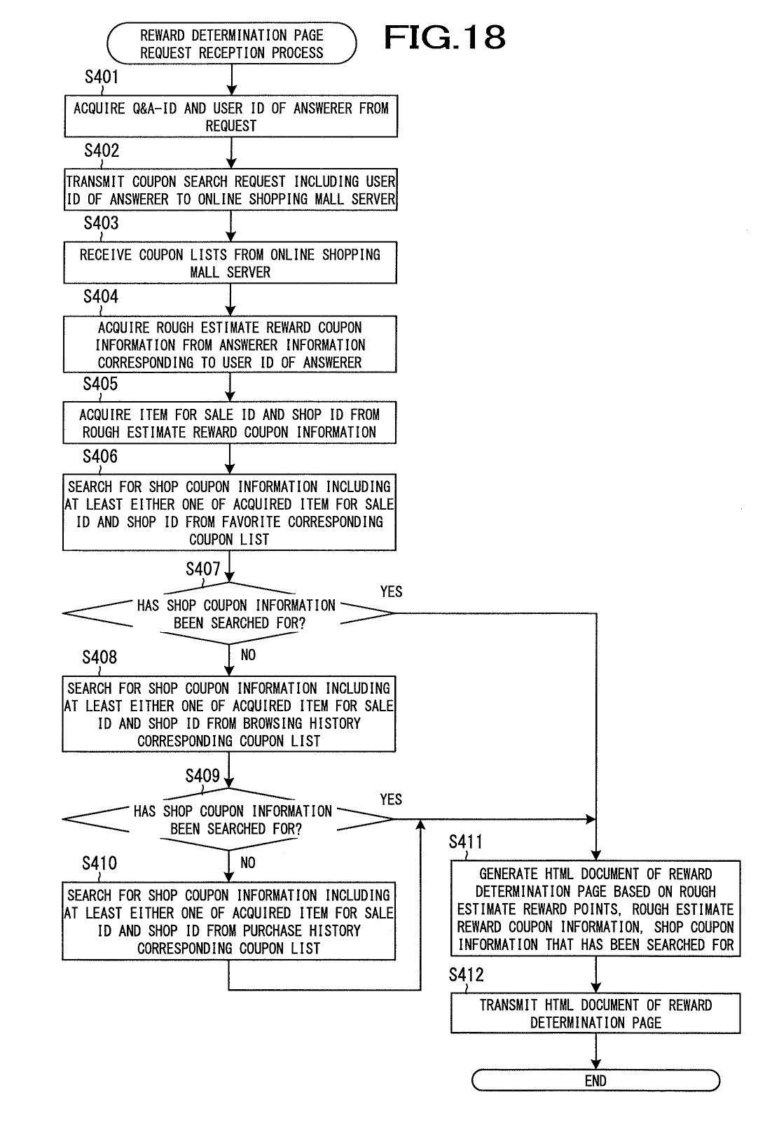

FIG. 18 is a flowchart showing a process example of the reward determination page request reception process of the system control unit 34 of the Q&A server 3 according to the embodiment.

As shown in FIG. 18, the system control unit 34 acquires the Q&A-ID and the user ID of the answerer from the reward determination page request (step S401). Next, the system control unit 34 transmits a coupon search request including the acquired user ID of the answerer to the online shopping mall server 2 (step S402). Thereafter, the system control unit 34 receives a favorite corresponding coupon list, a browsing history corresponding coupon list, a purchase history corresponding coupon list, which are transmitted from the online shopping mall server 2 (step S403).

Next, the system control unit 34 acquires the rough estimate reward coupon information from answerer information corresponding to the user ID of the answerer in the answerer information included in the questioner information corresponding to the acquired Q&A-ID (step S404). Next, the system control unit 34 acquires the shop ID from the acquired rough estimate reward coupon information and also acquires the item for sale ID set as the discount item for sale information in the rough estimate reward coupon information (step S405).

Next, the system control unit 34 searches for shop coupon information including at least either one of the acquired item for sale ID and shop ID from the favorite corresponding coupon list (step S406). When the discount item for sale information is the lower limit of the purchase price of an item for sale which the coupon can be used for, that is, when the discount item for sale information is not an item for sale ID, the system control unit 34 searches for shop coupon information including the shop ID. Next, the system control unit 34 determines whether or not the shop coupon information that satisfies the requirement has been searched for (step S407).

At this time, if the system control unit 34 determines that the shop coupon information has not been searched for (step S407: NO), the system control unit 34 searches for shop coupon information including at least either one of the acquired item for sale ID and shop ID from the browsing history corresponding coupon list (step S408). Next, the system control unit 34 determines whether or not the shop coupon information that satisfies the requirement has been searched for (step S409).

At this time, if the system control unit 34 determines that the shop coupon information has not been searched for (step S409: NO), the system control unit 34 searches for shop coupon information including at least either one of the acquired item for sale ID and shop ID from the purchase history corresponding coupon list (step S410). The reason why the priority order for searching for the shop coupon information is in order of the favorite corresponding coupon list, the browsing history corresponding coupon list, and the purchase history corresponding coupon list is the same as that of the question registration request reception process. When the number of pieces of the shop coupon information that have been searched for is smaller than a predetermined number, the system control unit 34 may integrate the search results from each coupon list.

When the system control unit 34 determines that the shop coupon information has been searched for in step S407 or S409 (step S407: YES or step S409: YES) or the system control unit 34 completes the process of step S410, the system control unit 34 generates an HTML document of the reward determination page (step S411). Specifically, the system control unit 34 acquires the number of the rough estimate reward points from the questioner information corresponding to the acquired Q&A-ID. Next, the system control unit 34 generates an HTML document based on the acquired number of the rough estimate reward points, the acquired rough estimate reward coupon information, the shop coupon information that has been searched for, and the like. When the rough estimate reward coupon information is not included in the shop coupon information that has been searched for, the HTML document is generated so that the rough estimate reward coupon area 403 is not displayed. When the shop coupon information that satisfies the requirement has not been searched for in step S410, the HTML document is generated so that the rough estimate reward coupon area 403 and the other coupons area 404 are not displayed in the reward determination page. In this case, the questioner can set only the number of points as a reward to be given in the reward determination page.

Next, as a coupon information transmission means, the system control unit 34 transmits the generated HTML document to the user terminal 5 that has transmitted the reward determination page request (step S412). After completing the process of step S412, the system control unit 34 ends the reward determination page request reception process.

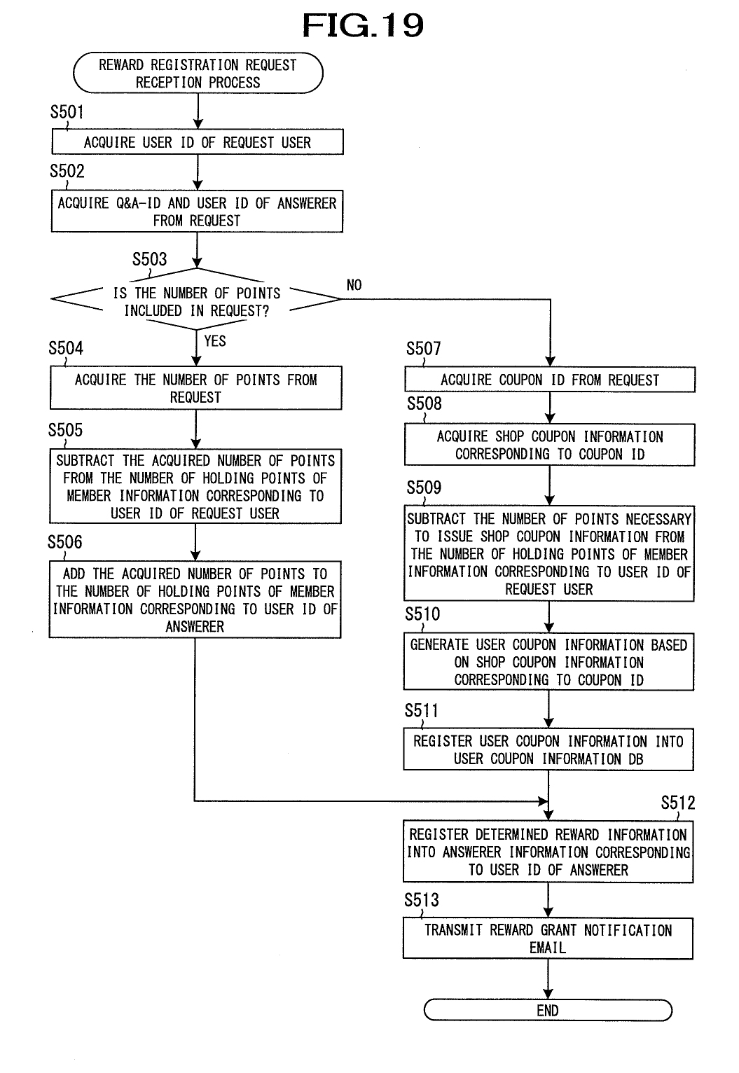

FIG. 19 is a flowchart showing a process example of the reward registration request reception process of the system control unit 34 of the Q&A server 3 according to the embodiment.

As shown in FIG. 19, the system control unit 34 acquires the user ID of the request user on the basis of the question registration request received from the user terminal 5 (step S501). Next, the system control unit 34 acquires the Q&A-ID and the user ID of the answerer from the received reward registration request (step S502). Next, the system control unit 34 determines whether or not the number of points is included in the reward registration request (step S503).

At this time, if the system control unit 34 determines that the number of points is included (step S503: YES), the system control unit 34 acquires the number of points from the reward registration request (step S504). Next, the system control unit 34 subtracts the acquired number of points from the number of points included in the member information corresponding to the user ID of the request user (step S505). Next, the system control unit 34 adds the acquired number of points to the number of points included in the member information corresponding to the user ID of the answerer (step S506).

In step S503, when the system control unit 34 determines that the number of points is not included in the reward registration request (step S503: NO), that is, when the coupon ID is included, the system control unit 34 acquires the coupon ID from the reward registration request (step S507). Next, the system control unit 34 acquires the shop coupon information corresponding to the acquired coupon ID from the shop coupon information DB 22f (step S508). Next, the system control unit 34 subtracts the number of points necessary to issue the coupon included in the acquired shop coupon information from the number of points included in the member information corresponding to the user ID of the request user (step S509). Next, the system control unit 34 generates user coupon information based on the shop coupon information (step S510). Specifically, the system control unit 34 acquires the shop ID, the coupon name, the discount item for sale information, the discount amount information, and the period of validity from the shop coupon information. Next, the system control unit 34 generates user coupon information including the user ID of the request user, the coupon ID, the information acquired from the shop coupon information, and the like. Next, the system control unit 34 registers the generated user coupon information into the user coupon information DB 22g (step S511).

After completing the process of step S506 or S511, as a storage control means, the system control unit 34 additionally registers the determined reward information into the answerer information corresponding to the user ID of the answerer in the answerer information included in the questioner information corresponding to the acquired Q&A-ID (step S512). Specifically, the system control unit 34 registers the determined number of reward points included in the reward registration request or the coupon ID as the determined reward information. The system control unit 34 changes the reward grant completion flag included in the answerer information corresponding to the user ID of the answerer to ON. When the coupon ID is included in the reward registration request, the system control unit 34 adds one to the number of coupons that have been issued, which is included in the shop coupon information corresponding to the coupon ID.

Next, the system control unit 34 transmits a reward grant notification email (step S513). Specifically, the system control unit 34 generates a reward grant notification email including the determined number of reward points or content of the coupon corresponding to the coupon ID of the determined reward coupon in its body text. Next, the system control unit 34 acquires an email address from the member information corresponding to the user ID of the answerer. Next, the system control unit 34 sets a destination address of the reward grant notification email to the acquired email address. Then, the system control unit 34 transmits the generated reward grant notification email. After completing the process of step S513, the system control unit 34 ends the reward registration request reception process.

The update of the number of holding points (steps S505, S506, and S509) is performed on the member information DB 1a. Therefore, the system control unit 34 causes the database management server 1 to updates the number of holding points by transmitting a request to the database management server 1. Also, the system control unit 34 acquires the shop coupon information from the online shopping mall server 2 (step S508) and causes the online shopping mall server 2 to register the user coupon information (step S511) by transmitting a request to the online shopping mall server 2.

As described above, according to the embodiment, the system control unit 34 of the Q&A server 3 receives the question registration request including the question information, the purchase history requirements, and the attribute requirements from the user terminal 5 used by the questioner, acquires one or more user IDs that have been searched for by the online shopping mall server 2 which searches for the user IDs of users who satisfy the purchase history requirements and the attribute requirements included in the question registration request on the basis of the purchase history DB 22e and the member information DB 1a, transmits the answerer Q&A page on which the received question information is displayed to the user terminals 5 used by the selected persons corresponding to the acquired user IDs, receives the determined reward point or the coupon ID of the determined reward coupon from the user terminal 5 used by the questioner who receives the questioner Q&A page on which the answer information transmitted from the user terminal 5 used by the selected person is displayed, and registers the received determined number of reward points into the member information DB 1a in association with the user ID of the answerer or registers the user coupon information corresponding to the received coupon ID into the user coupon information DB 22g.

Therefore, it is possible to obtain a serious answer from a user who has a purchase history and an attribute desired by the questioner. Further, the answerer can obtain points or a coupon that can be used to purchase an item for sale. Therefore, it is possible to promote purchase of the item for sale. Further, it is possible to increase motivation for the selected person to provide an answer.

The system control unit 34 of the Q&A server 3 receives the question information, the purchase history requirements, the attribute requirements, and the number of the rough estimate reward points from the user terminal 5 used by the questioner and transmits the answerer Q&A page on which the received question information and the number of the rough estimate reward points are displayed to the user terminal 5 used by the selected person.

Therefore, the selected person can determine whether or not to provide an answer after checking the rough estimate of the reward that may be obtained if the selected person provides an answer.

The system control unit 34 of the Q&A server 3 transmits the reward history page on which the number of the rough estimate reward points and the determined reward information are displayed to the user terminal 5 used by the selected person.

Therefore, the selected person can check the rough estimates of the reward which were determined by the questioner in the past and the rewards which were actually given by the questioner. Thus, the selected person can determine whether or not to provide an answer after studying whether or not the questioner is a user who gives a reward according to the rough estimate of the reward.

The system control unit 34 of the Q&A server 3 transmits the reward history page on which the number of the rough estimate reward points, the determined reward information, and the answer information are displayed to the user terminal 5 used by the selected person.

Therefore, the selected person can check the rough estimates of the reward which were determined by the questioner in the past, the rewards which were actually given by the questioner, and content of the answer when each reward was given. Thus, the selected person can determine whether or not to provide an answer after studying what kind of answer the questioner prefers.

The system control unit 34 of the Q&A server 3 transmits the reward determination page on which the shop coupon information is displayed as a candidate of the reward given to the answerer to the user terminal 5 used by the questioner and receives the coupon ID of the shop coupon information selected by the questioner.

Therefore, the questioner can select a coupon as the reward to be given to the answerer after considering the number of points defrayed by the questioner to give the coupon. Thus, the questioner can give a coupon with a value according to the content of the answer.

The system control unit 34 of the Q&A server 3 acquires the shop coupon information including the number of points necessary to issue the coupon corresponding to the number of the rough estimate reward points from the shop coupon information DB 22f through the online shopping mall server 2 as the rough estimate reward coupon information and transmits the answerer Q&A page on which the question information and the acquired rough estimate reward coupon information are displayed to the user terminal 5 used by the selected person.

Therefore, as the rough estimate of the reward, the information of the coupon corresponding to the number of points which the questioner think he or she will defray is presented to the selected person. Thus, the selected person can determine whether or not to provide an answer after checking the coupon that may be obtained if the selected person provides an answer.

The system control unit 24 of the online shopping mall server 2 receives coupon information set by a shop from the shop terminal 4 and registers shop coupon information including the received coupon information and the shop ID of the shop which sets the coupon information into the shop coupon information DB 22f.

When a user purchases an item for sale, the system control unit 24 searches for user coupon information including the item for sale ID of the item for sale to be purchased and user coupon information including the shop ID of the shop which sells the item for sale to be purchased, transmits the order procedure page on which the coupon indicated by the user coupon information that has been searched for can be selected to be used to purchase the item for sale to the user terminal 5.

Therefore, the shop sets a coupon which the shop may issue to the answerer, so that when the coupon is given to the answerer, a possibility occurs where the answerer purchases an item for sale from this shop by using this coupon. Thus, it is possible to promote the purchase of items for sale provided by the shop which sets the coupon. Further, the shop can issue a coupon that can discount the price of an item for sale more than a discount amount when the coupon is issued by the shop independently by the same cost defrayed by the shop when the shop issues the coupon independently.

The system control unit 24 of the online shopping mall server 2 transmits the coupon registration page on which it is impossible to input the number of points necessary to issue the coupon which is greater than or equal to the number of points corresponding to the amount of money discounted by the use of the coupon to the shop terminal 4. Therefore, the questioner can give a coupon with a value higher than the value of the number of points defrayed by the questioner. Thus, it is possible to increase motivation for the selected person to provide an answer. Even when the shop defrays part of the cost to issue the coupon, the shop can promote the purchase of items for sale provided by the shop.

The system control unit 24 of the online shopping mall server 2 searches for the item for sale ID of an item for sale to be recommended to the selected person and the shop ID of a shop to be recommended to the selected person to purchase an item for sale on the basis of at least any one of the favorite information DB 22c, the browsing history DB 22d, and the purchase history DB 22e and the system control unit 34 of the Q&A server 3 acquires shop coupon information including at least either one of the item for sale ID and the shop ID that have been searched for and transmits the reward determination page to the user terminal 5 used by the questioner. On the reward determination page, the acquired shop coupon information is displayed so that the shop coupon information can be selected.

Therefore, the questioner can give a coupon of an item for sale suitable for the answerer or a coupon issued by a provider suitable for the answerer to the answerer without an effort to search for a provider that issues a coupon in the online shopping mall.

The system control unit 34 of the Q&A server 3 acquires addresses corresponding to the user IDs of users who satisfy the purchase history requirements and the attribute requirements from the member information DB 1a, generates, on the basis of the acquired addresses, the object display information for the user terminal 5 to display a map showing a distribution of the users who satisfy the purchase history requirements and the attribute requirements, and transmits the generated object display information to the user terminal 5 used by the questioner.

Therefore, it is possible to present the information indicating where the users live who satisfy the purchase history requirements and the attribute requirements specified by the questioner in an easy-to-understand manner to the questioner. The questioner can ask a question after grasping the distribution of the users.

The system control unit 34 of the Q&A server 3 transmits the object display information for the user terminal 5 to display the map on which the user objects indicating the users who satisfy the purchase history requirements and the attribute requirements are arranged to the user terminal 5 used by the questioner, receives the question information and the user ID of the user indicated by the user object selected by the questioner, and transmits the answerer Q&A page on which the received question information is displayed to the user terminal 5 used by the selected person corresponding to the received user ID.

Therefore, the user indicated by the user object selected on the map is the selected person. Therefore, the questioner can easily narrow down the area where the selected persons live and the number of the selected persons while grasping the distribution of the users who satisfy the purchase history requirements and the attribute requirements.

On the Q&A site, it is possible to require the questioner to defray some cost according to the number of the selected persons to be requested to provide an answer. This is because the greater the number of the selected persons is, the higher the processing load of the Q&A server 3 is. For example, when the Q&A server 3 registers the questioner information into the Q&A information DB 32a, the Q&A server 3 may subtract the number of points based on the number of the selected persons from the number of points held by the questioner. On the other hand, the questioner can grasp the number of the answerer candidates who satisfy the requirements set on the question input page. Therefore, the questioner can adjust the cost defrayed by the questioner by adjusting the purchase history requirements and the attribute requirements and a selection operation of the user objects 110.

The online shopping mall and the Q&A site need not belong to the same service providing site. Business operators that operate the online shopping mall and the Q&A site need not be the same business operator. In this case, a user needs to register as a member in both the online shopping mall and the Q&A site. The electronic commerce site of the present invention may be applied to a Web site in which one or more item for sale can be purchased from only one shop or the like.

Instead of the database management server 1, the online shopping mall server 2 or the Q&A server 3 may have a configuration corresponding to the database management server 1. Further, for example, instead of the Q&A server 3, the online shopping mall server 2 may have a configuration corresponding to the Q&A server 3.

The transaction target of the present invention may be applied to, for example, a predetermined service. Examples of the service include providing an accommodation facility, providing a golf course, arranging a seat on a transport facility, arranging a seat in a performance facility, and the like. The reward of the present invention may be points or a coupon that can be used to purchase a service. Also, the reward of the present invention may be, for example, money, electronic money, and a gift voucher that have a value in exchange with a transaction target or may be points and an evaluation value that have no value in exchange with a transaction target.

As shown in FIG. 10, for example, after the distribution of the answerer candidates is displayed on the question input page, the questioner may specify the number of answerer candidates to be the selected persons from the answerer candidates and transmit the question information. In other words, the number of the users to be actually requested to provide an answer may be narrowed down from the answerer candidates who have been searched for. For example, an input field for inputting the number of the answerer candidates to be the selected persons is provided on the question input page. When the questioner inputs a number into the input field and selects the transmission icon 104, the user terminal 5 transmits the question registration request further including the inputted number to the Q&A server 3. The Q&A server 3 selects answerer candidates, the number of which is the number included in the question registration request, from the answerer candidates who have been searched for, as the selected persons. For example, the Q&A server 3 may randomly select from the answerer candidates.

The Q&A server 3 may be configured so that the questioner can specify at least either of the purchase history requirements or the user attribute requirements as the requirements of a user to be an answerer. When the Q&A server 3 is configured so that the questioner can determine the reward to the answerer, the questioner may ask a question without specifying any of the purchase history requirements or the user attribute. In this case, all the members of the service providing site can provide an answer. In this case, it may be configured so that the answer request email need not be transmitted. Also, in this case, it may be configured so that a user searches for Q&As by a keyword search or the like and the user can provide an answer to a desired Q&A among the Q&As that have been searched for. When the Q&A server 3 is configured so that the questioner can specify the requirements of a user to be an answerer, it may be configured so that the reward is not given from the questioner to the answerer.

### REFERENCE SIGNS LIST

1 Database management server
1a Member information DB
2 Online shopping mall server
3 Q&A server
4 Shop terminal
5, 5A, 5B User terminal
21 Communication unit
22 Storage unit
22a Shop information DB
22b Items-for-sale information DB
22c Favorite information DB
22d Browsing history DB
22e Purchase history DB
22f Shop coupon information DB
22g User coupon information DB
23 Input/output interface
24 System control unit
24a CPU
24b ROM
24c RAM
25 System bus
31 Communication unit
32 Storage unit
32a Q&A information DB
32b Map information DB
33 Input/output interface
34 System control unit
34a CPU
34b ROM
34c RAM
35 System bus
NW, NL Network
S Service providing system

1. A question and answer processing device to which terminal devices used by users to exchange questions and answers between users can be connected through a network, the question and answer processing device comprising:
a question information reception unit that receives question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user;
an acquisition unit that acquires user identification information having been searched for by a search unit, the user identification information identifying a user, the search unit searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information;
a question information transmission unit that transmits the received question information to an answerer terminal device being the terminal device used by a user identified by the acquired user identification information;
a determined reward information reception unit that receives determined reward information from the questioner terminal device having received answer information transmitted from the answerer terminal device, the determined reward information indicating a reward determined by a questioner for the answer information; and
a storage control unit that causes a storage unit to store the received determined reward information in association with the user identification information of an answerer, the storage unit storing information indicating things obtained by a user.

2. The question and answer processing device according to claim 1, wherein
the question information reception unit receives the question information, the purchase history requirement information, the attribute requirement information and rough estimate reward information from the questioner terminal device, the rough estimate reward information indicating a rough estimate of a reward estimated by the questioner, and
the question information transmission unit transmits the received question information and the received rough estimate reward information to the answerer terminal device.

3. The question and answer processing device according to claim 2, further comprising:
a reward history information storage unit that stores reward history information in association with the user identification information of the questioner, the reward history information including the rough estimate reward information and the determined reward information which are received from the questioner terminal device; and
a reward history information transmission unit that transmits the reward history information having been stored so far in the reward history information storage unit in association with the user identification information of the questioner to the answerer terminal device.

4. The question and answer processing device according to claim 3, further comprising:
an answer information reception unit that receives answer information from the answerer terminal device; and
an answer information transmission unit that transmits the received answer information to the questioner terminal device,
wherein the reward history information storage unit stores the reward history information including the rough estimate reward information, the determined reward information and the answer information, the rough estimate reward information and the determined reward information being received from the questioner terminal device, the answer information being received from the answerer terminal device.

5. The question and answer processing device according to claim 1, wherein
in the storage unit, coupon information indicating a coupon being able to be used to purchase the transaction target is stored in association with the user identification information,
the determined reward information reception unit receives coupon identification information identifying a coupon having been determined by the questioner as a coupon to be given, and
the storage control unit causes the storage unit to store the coupon information as the determined reward information in association with the user identification information of the answerer, the coupon information as the determined reward information being identified by the received coupon identification information.

6. The question and answer processing device according to claim 5, further comprising:
a coupon information transmission unit that transmits one or more pairs of the coupon information and cost information which are stored in a coupon information storage unit to the questioner terminal device, the coupon information storage unit storing the coupon information and the cost information in association with each other, the cost information indicating a cost defrayed by the questioner to give a coupon, wherein the determined reward information reception unit receives the coupon identification information of the coupon information selected by the questioner from the coupon information transmitted to the questioner terminal device.

7. The question and answer processing device according to claim 6, wherein
the question information reception unit receives rough estimate cost information as the rough estimate reward information, the rough estimate cost information indicating a rough estimate of a cost estimated by the questioner,
the question and answer processing device further comprises a coupon information acquisition unit that acquires the coupon information corresponding to a cost indicated by the received rough estimate cost information from the coupon information storage unit,
the question information transmission unit transmits the received question information and the acquired coupon information to the answerer terminal device, and
the coupon information transmission unit transmits at least the acquired coupon information to the questioner terminal device.

8. The question and answer processing device according to claim 1, wherein
in the coupon information storage unit, the coupon information and the cost information are stored in association with each other, the coupon information having been set by a provider providing the transaction target, the coupon information indicating that the coupon can be used to the provider having set the coupon information, the cost information having been set by the provider.

9. The question and answer processing device according to claim 8, wherein
in the coupon information storage unit, the coupon information indicating content of discount of purchase price and the cost information indicating an amount of a cost corresponding to an amount of money smaller than an amount of money to be discounted by use of a coupon are stored in association with each other.

10. The question and answer processing device according to claim 1, wherein
in the coupon information storage unit, the coupon information indicating provider identification information identifying the provider having set a coupon and the cost information are stored in association with each other, and
the coupon information transmission unit transmits the coupon information including the provider identification information searched for by a provider identification information search unit and the cost information corresponding to the coupon information to the questioner terminal device, the provider identification information search unit searching for the provider identification information the provider identification information search unit searching for the provider identification information of the provider to be recommended to a user indicated by the user identification information acquired by the acquisition unit, the provider identification information search unit searching for the provider identification information on the basis of personal information of a user, the personal information being registered according to an operation of the user on an electronic commerce site where the transaction target provided from the provider can be purchased.

11. The question and answer processing device according to claim 1, wherein
in the coupon information storage unit, the coupon information including transaction target identification information and the cost information are stored in association with each other, the transaction target identification information identifying a transaction target for which a coupon can be used, and
the coupon information transmission unit transmits the coupon information including the transaction target identification information searched for by a transaction target identification information search unit and the cost information corresponding to the coupon information to the questioner terminal device, the transaction target identification information search unit searching for the transaction target identification information of the transaction target to be recommended to a user indicated by the user identification information acquired by the acquisition unit, the transaction target identification information search unit searching for the transaction target identification information on the basis of personal information of a user, the personal information being registered according to an operation of the user on an electronic commerce site where the transaction target can be purchased.

12. The question and answer processing device according to claim 1, further comprising:
an address information acquisition unit that acquires address information of a user identified by the acquired user identification information;
a generation unit that generates display information on the basis of the acquired address information, the display information being used for displaying a map showing a distribution of users identified by the acquired user identification information; and
a display information transmission unit that transmits the generated display information to the questioner terminal device,
wherein the question information reception unit receives question information from the questioner terminal device having displayed the map based on the display information.

13. The question and answer processing device according to claim 12, wherein
the generation unit generates the display information for displaying the map on which an object indicating a user identified by the acquired user identification information is arranged,
the question information reception unit receives the question information and the user identification information of a user indicated by the object selected by the questioner from the questioner terminal device having displayed the map on which the object is arranged based on the display information, and
the question information transmission unit transmits the received question information to the answerer terminal device used by a user identified by the user identification information received from the questioner terminal device.

14. The question and answer processing device according to claim 1, wherein
in the storage unit, the number of points held by a user as points being able to be used to purchase the transaction target is stored in association with the user identification information,
the determined reward information reception unit receives the number of points determined by the questioner as points to be given, and
the storage control unit subtracts the received number of points from the number of points stored in the storage unit in association with the user identification information identifying the questioner and adds the received number of points to the number of points stored in the storage unit in association with the user identification information of the answerer.

15. The question and answer processing device according to claim 1, wherein
the question information reception unit receives the purchase history requirement information including a requirement of a purchase period and the attribute requirement information including a requirement of an address.

16. A question and answer processing method in a question and answer processing device to which terminal devices used by users to exchange questions and answers between users can be connected through a network, the question and answer processing method comprising:
a question information reception step of receiving question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user;
an acquisition step of acquiring user identification information having been searched for by a search unit, the user identification information identifying a user, the search unit searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information;
a question information transmission step of transmitting the received question information to an answerer terminal device being the terminal device used by a user identified by the acquired user identification information;
a determined reward information reception step of receiving determined reward information from the questioner terminal device having received answer information transmitted from the answerer terminal device, the determined reward information indicating a reward determined by a questioner for the answer information; and
a storage control step of causing a storage unit to store the received determined reward information in association with the user identification information of an answerer, the storage unit storing information indicating things obtained by a user.

17. (canceled)

18. A non-transitory recording medium in which a question and answer processing program is computer-readably recorded, the question and answer processing program causing a computer included in a question and answer processing device to which terminal devices used by users to exchange questions and answers between users can be connected through a network to function as:
a question information reception unit that receives question information, purchase history requirement information and attribute requirement information from a questioner terminal device being the terminal device used by a questioner, the purchase history requirement information indicating requirements of a purchase history of a transaction target being at least either one of an item for sale or a service, the attribute requirement information indicating requirements of a attribute of a user;
an acquisition unit that acquires user identification information having been searched for by a search unit, the user identification information identifying a user, the search unit searching for the user identification information of a user satisfying requirements indicated by the received purchase history requirement information and by the attribute requirement information on the basis of purchase history information and attribute information, the purchase history information indicating a purchase history of the transaction target in association with the user identification information, the attribute information indicating an attribute of a user in association with the user identification information;
a question information transmission unit that transmits the received question information to an answerer terminal device being the terminal device used by a user identified by the acquired user identification information;
a determined reward information reception unit that receives determined reward information from the questioner terminal device having received answer information transmitted from the answerer terminal device, the determined reward information indicating a reward determined by a questioner for the answer information; and
a storage control unit that causes a storage unit to store the received determined reward information in association with the user identification information of an answerer, the storage unit storing information indicating things obtained by a user.
